(19) United States
(12) Patent Application Publication
(10) Pub. No.: US 2015/0225500 A1
(43) Pub. Date: Aug. 13, 2015

(54) COLORED PARTICLE FOR ELECTROWETTING DISPLAY, METHOD FOR PRODUCING COLORED PARTICLE FOR ELECTROWETTING DISPLAY, INK FOR ELECTROWETTING DISPLAY, AND ELECTROWETTING DISPLAY

(71) Applicant: SEKISUI CHEMICAL CO., LTD., Osaka-city, Osaka (JP)

(72) Inventors: Yu Nagahara, Tsukuba-city (JP); Takeshi Wakiya, Tsukuba-city (JP)

(73) Assignee: SEKISUI CHEMICAL CO., LTD., Osaka-city, Osaka (JP)

(21) Appl. No.: 14/421,032

(22) PCT Filed: Aug. 29, 2013
(86) PCT No.: PCT/JP2013/073159

§ 371 Date: Feb. 11, 2015

(30) Foreign Application Priority Data
Aug. 31, 2012 (JP) 2012-192196
Dec. 28, 2012 (JP) 2012-288355
Jan. 31, 2013 (JP) 2013-017471
Jan. 31, 2013 (JP) 2013-017472

(51) Int. Cl. C08F 236/08; G02B 26/00; C08F 112/08; C08F 120/10; C08F 226/06; G02B 1/04; C08F 212/08

(52) U.S. Cl. CPC C08F 236/08; G02B 1/04; G02B 26/005; C08F 212/08; C08F 120/10; C08F 226/06; C08F 112/08

(57) ABSTRACT

Provided is a colored particle used for an electrowetting display that is capable of enhancing the dispersibility in an ink for an electrowetting display. In the colored particle for an electrowetting display according to the present invention, a surface of the particle is formed from a compound containing only a carbon atom and a hydrogen atom as constituent atoms or a surface of the particle is formed from a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more.

### TECHNICAL FIELD

The present invention relates to a colored particle used for an electrowetting display, and a method for producing the colored particle. Further, the present invention relates to an ink for an electrowetting display using the colored particle, and an electrowetting display.

### BACKGROUND ART

In recent years, an electrowetting display (hereinafter sometimes referred to as EWD) that utilizes an electrowetting effect has attracted attention. The EWD includes a hydrophilic liquid and a hydrophobic liquid between two opposed substrates. The hydrophobic liquid generally includes a coloring component. One of the substrates has an electrode layer on a surface thereof and a hydrophobic intermediate layer (insulating layer) on a surface of the electrode layer. When a voltage is applied to the hydrophilic liquid and the electrode layer via the hydrophobic intermediate layer, the hydrophilic liquid is attracted to the hydrophobic intermediate layer, and an interface between the hydrophilic liquid and the hydrophobic liquid in the EWD changes in the shape. As a result, the hydrophobic liquid (oil layer) shifts to expose a transparent portion or the like, and thus an image is displayed.

As one example of the hydrophobic liquid, a composition containing a dye and oil is disclosed in Patent Document 1 described below. The composition contains the dye as a coloring component. Specific examples of the dye may include Sudan Red 500, Sudan Blue 673, and Sudan Yellow 172 (available from BASF).

Patent Document 2 discloses a conductive particle containing a polymer of a pyrrole or a pyrrole derivative, an anionic surfactant, and a dopant, which are not the colored particle used for the EWD. A solution of a dopant is added to a monomer of a pyrrole or a pyrrole derivative in an oil-in-water emulsion liquid obtained by mixing and stirring an organic solvent, water, an anionic surfactant, and an oxidizer, resulting in oxidative polymerization of the monomer. As a result, the conductive particle is obtained.

### RELATED ART DOCUMENT

### Patent Document

Patent Document 1: WO 2005/098524 A1

Patent Document 2: JP-B-4501030

### SUMMARY OF THE INVENTION

### Problems to be Solved by the Invention

When the composition containing a dye and oil that is described in Patent Document 1 is used as an ink for an EWD, the hiding performance of the coloring component may be low. Conventionally, a pigment may be also used as the coloring component. However, a pigment used for a conventional EWD has a problem of low dispersibility in an ink for an EWD. When an ink for an EWD in which the pigment is settled is used to produce an EWD, the hiding performance of the pigment decreases. Therefore, a vivid image is not obtained, or image unevenness is caused.

The conductive particle described in Patent Document 2 is not a colored particle for an EWD. Patent Document 2 does not describe that the conductive particle described in Patent Document 2 is used as a colored particle for an EWD. It may not be considered that the conductive particle is used as the colored particle for an EWD. However, even if the colored particle is dispersed in a hydrophobic liquid used for an EWD, there is a problem of low dispersibility of the colored particle. In addition, there is a problem of use of a large amount of surfactant to enhance the dispersibility. Therefore, it is difficult to use the conductive particle described in Patent Document 2 as the colored particle for an EWD.

A main object of the present invention is to provide a colored particle used for an electrowetting display that is capable of enhancing the dispersibility in an ink for an electrowetting display, and a method for producing the colored particle.

An additional object of the present invention is to provide an ink for an electrowetting display using the colored particle, and an electrowetting display.

### Means for Solving the Problems

A wide aspect of the present invention provides a colored particle for an EWD of which a surface is formed from a compound containing only a carbon atom and a hydrogen atom as constituent atoms; or a surface that is formed from a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more.

In a specific aspect of a colored particle for an EWD according to the present invention, a surface-forming material to form the particle surface is a polymer of a polymerization component containing at least one selected from the group consisting of styrene, isoprene, isobutylene, 1-butene, 1-pentene, 1-hexene, 1-octene, and butadiene or a hydrogenated product of the polymer; or a polymer of alkyl (meth)acrylate having an alkyl group having 12 to 18 carbon atoms.

In a specific aspect of the colored particle for an EWD according to the present invention, the surface-forming material to form the particle surface is a polymer of a polymerization component containing at least one selected from the group consisting of styrene, isoprene, isobutylene, 1-butene, 1-pentene, 1-hexene, 1-octene, and butadiene or a hydrogenated product of the polymer.

In a specific aspect of the colored particle for an EWD according to the present invention, the colored particle for an EWD contains a polymer obtained by polymerization of a polymerizable compound that forms a π-conjugated polymer by polymerization, comprising a carbon particle, or comprising a dye.

In a specific aspect of the colored particle for an EWD according to the present invention, the colored particle for an EWD contains a polymer obtained by polymerization of a polymerizable compound that forms a π-conjugated polymer by polymerization, or comprising a carbon particle.

In a specific aspect of the colored particle for an EWD according to the present invention, the colored particle for an EWD is obtained by polymerization of a polymerizable compound that forms a π-conjugated polymer by polymerization.

In a specific aspect of the colored particle for an EWD according to the present invention, the colored particle for an EWD contains a carbon particle.

In a specific aspect of the colored particle for an EWD according to the present invention, the colored particle for an EWD includes the carbon particle and a surface portion that is disposed on a surface of the carbon particle and constitutes a surface of the particle.

A wide aspect of the present invention provides a method for producing the colored particle for an EWD that includes a step of polymerizing a polymerizable compound that forms a π-conjugated polymer by polymerization to obtain the colored particle for an EWD of which the surface is formed from a compound containing only a carbon atom and a hydrogen atom as constituent atoms or the surface is formed from a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more, a step of surface-treating a carbon particle to dispose a surface portion that constitutes a surface of the particle on a surface of the carbon particle, obtaining the colored particle for an EWD of which the surface is formed from a compound containing only a carbon atom and a hydrogen atom as constituent atoms or the surface is formed from a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more, or a step of surface-treating a dye-containing particle material that contains a substrate particle and a dye in the substrate particle to obtain the colored particle for an EWD of which the surface is formed from a compound containing only a carbon atom and a hydrogen atom as constituent atoms or the surface is formed from a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more.

A wide aspect of the present invention provides an ink for an EWD containing the colored particle for an EWD and a hydrophobic solvent.

A wide aspect of the present invention provides an EWD that includes first and second opposed substrates, a first liquid that is disposed on a side of the first substrate between the first and second substrates, and an ink for an EWD that is disposed on a side of the second substrate between the first and second substrates, wherein the ink for an EWD contains the colored particle for an EWD and a hydrophobic solvent.

### Effect of the Invention

In a colored particle for an electrowetting display according to the present invention, a surface of the particle is formed from a compound containing only a carbon atom and a hydrogen atom as constituent atoms or a surface is formed from a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more. Therefore, the dispersibility of the colored particle for an electrowetting display in an ink for an electrowetting display can be enhanced.

### BRIEF DESCRIPTION OF THE DRAWINGS

FIG. 1 is a cross-sectional view schematically illustrating a colored particle for an electrowetting display according to a first embodiment of the present invention.

FIG. 2 is a cross-sectional view schematically illustrating a colored particle for an electrowetting display according to a second embodiment of the present invention.

FIG. 3 is a cross-sectional view schematically illustrating a colored particle for an electrowetting display according to a third embodiment of the present invention.

FIG. 4 is a cross-sectional view schematically illustrating an electrowetting display using a colored particle for an electrowetting display according to an embodiment of the present invention.

FIG. 5 is a cross-sectional view schematically illustrating an action concept of the electrowetting display shown in FIG. 4.

### MODE(S) FOR CARRYING OUT THE INVENTION

Hereinafter, the present invention will be described in detail.

(Colored particle for EWD)

In a colored particle for an electrowetting display (EWD) according to the present invention, a surface of the particle is formed from a first compound containing only a carbon atom and a hydrogen atom as constituent atoms or a surface is formed from a second compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more. Specifically, the colored particle for an EWD has a surface that is formed from the first compound containing only a carbon atom and a hydrogen atom as constituent atoms or a surface that is formed from the second compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more. The total of constituent atoms of 100% by mass means that the total of atoms constituting the first or second compound is 100% by mass. The total amount of a carbon atom, a hydrogen atom, an oxygen atom, a nitrogen atom, and a sulfur atom is 95% by mass or more relative to 100% by mass of total of constituent atoms of the second compound. In the second compound, the mass ratio of the amount of the carbon atom to the total amount of the oxygen atom, the nitrogen atom, and the sulfur atom is 5 or more.

Since the colored particle for an EWD according to the present invention has a surface that is formed from a compound having a specific atom configuration, as described above, the hydrophobicity of the particle surface is sufficiently high. Therefore, when the colored particle for an END according to the present invention is used for an ink for an END, the dispersibility of the colored particle for an EWD in the ink for an EWD can be enhanced. In particular, the dispersibility of the colored particle for an EWD in a hydrophobic solvent is enhanced. As the mass ratio of the amount of the carbon atom to the total amount of the oxygen atom, the nitrogen atom, and the sulfur atom (amount (C)/(amount (O)+amount (N)+amount (S)) in the second compound is larger, the hydrophobicity on the surface of the colored particle for an EWD is higher.

It is preferable that the colored particle for an EWD be a black particle for an EWD. When the colored particle for an EWD is the black particle for an EWD, the hiding properties of the colored particle are higher.

It is preferable that the colored particle for an EWD contain a polymer obtained by polymerization of a polymerizable compound that forms π-conjugated polymer by polymerization, a carbon particle, a dye, or an inorganic pigment. It is preferable that the colored particle for an EWD contain a polymer obtained by polymerization of a polymerizable compound that forms a π-conjugated polymer by polymerization, a carbon particle, or a dye. In this case, it is preferable that the colored particle for an EWD contain a polymer obtained by polymerization of a polymerizable compound that forms a π-conjugated polymer by polymerization or a carbon particle, a polymer obtained by polymerization of a polymerizable compound that forms a π-conjugated polymer by polymerization or a dye, or a carbon particle or a dye. The colored particle for an EWD may contain a polymer obtained by polymerization of a polymerizable compound that forms a π-conjugated polymer by polymerization, be a polymer particle, contain a carbon particle, be a carbon-modified particle containing a carbon particle, contain a dye, or be a dye-containing particle containing a dye. The colored particle for an EWD may be an inorganic pigment-modified particle containing an inorganic pigment, or contain an inorganic pigment.

When the colored particle for an EWD contains the carbon particle, it is preferable that the colored particle for an EWD include the carbon particle and a surface portion that is disposed on a surface of the carbon particle and constitutes a surface of the particle. When the colored particle for an EWD contains the dye, it is preferable that the colored particle for an EWD include a substrate particle and the dye contained in the substrate particle.

In particular, it is preferable that the colored particle for an EWD be a polymer particle for an EWD or a carbon-modified particle for an EWD, as described below. The colored particle for an EWD may be a polymer particle for an EWD or a carbon-modified particle for an EWD.

Polymer Particle:

It is preferable that the polymer particle for an EWD be obtained by polymerization of a polymerizable compound that forms a π-conjugated polymer by polymerization. It is preferable that the colored particle for an EWD include a polymer substrate particle and a surface portion that is disposed on a surface of the polymer substrate particle and constituents a particle surface that is formed from a compound containing only a carbon atom and a hydrogen atom as constituent atoms or a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more. In the preferred embodiments, the colored particle for an EWD is a polymer particle for an EWD, and generally a black particle for an EWD.

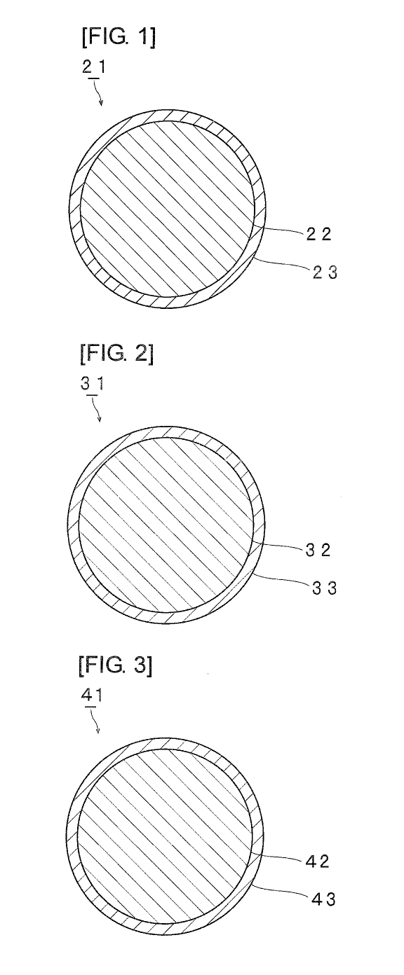

FIG. 1 is a cross-sectional view schematically illustrating a colored particle for an electrowetting display (EWD) according to a first embodiment of the present invention.

The colored particle for an electrowetting display (EWD) shown in FIG. 1 is a polymer particle 21 for an EWD. The polymer particle for an EWD 21 includes a polymer substrate particle 22 and a surface portion 23 that is disposed on a surface of the polymer substrate particle 22 and constitutes a particle surface. The surface portion 23 is preferably a surface layer. In the polymer particle for an EWD 21, the particle surface is formed from a compound having the atom configuration as described above.

Carbon-Modified Particle:

It is preferable that the colored particle for an EWD include a carbon particle and a surface portion that is disposed on a surface of the carbon particle and constituents a particle surface that is formed from a compound containing only a carbon atom and a hydrogen atom as constituent atoms or a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more. In the preferred embodiment, the colored particle for an EWD is a carbon-modified particle for an EWD, or a black particle for an EWD.

Conventionally, a pigment may be used as a coloring component. However, a conventional pigment used for an EWD has a problem of low dispersibility in an ink for an EWD. When an ink for an EWD in which a pigment is settled is used to produce an EWD, the hiding performance of the pigment decreases. Therefore, a vivid image is not obtained, or image unevenness is caused.

The black degree of a carbon pigment is high. Therefore, if the carbon pigment is used as a coloring component for an EWD, the hiding properties may be enhanced. However, the carbon pigment generally has high conductivity. Therefore, the carbon pigment cannot be used as the coloring component for an EWD as it is. If the carbon pigment is used as the coloring component for an EWD, the viewing quality in the EWD cannot be improved due to high conductivity of the carbon pigment. Specifically, the carbon pigment has been conventionally considered to be unsuitable for the coloring component for an EWD, and is not used as the coloring component for an EWD.

Further, the carbon-modified particle for an EWD has a particle surface formed from a compound having the specific atom configuration. Therefore, even when the carbon particle itself has high conductivity, the conductivity of the carbon-modified particle can be decreased. Accordingly, the carbon particle that cannot be used for an EWD may be used in the form of carbon-modified particle for an EWD. Use of the carbon-modified particle for an EWD can improve the viewing quality of an EWD.

When the carbon particle or the carbon-modified particle has no specific particle surface, the dispersibility of the particle in a hydrophobic solvent decreases.

Since the carbon-modified particle for an EWD has the specific particle surface, the hydrophobicity of the particle surface can be sufficiently enhanced. Therefore, when the carbon-modified particle for an EWD is used for an ink for an EWD, the dispersibility of the carbon-modified particle for an EWD in the ink for an EWD can be enhanced.

Since in the carbon-modified particle for an EWD, the carbon particle is used, the black degree of an ink for an EWD can be sufficiently enhanced, and extremely high hiding properties can be exerted.

A particle surface having the specific atom configuration is easily formed. Therefore, it is preferable that the carbon-modified particle be obtained by surface-treating the carbon particle to dispose a surface portion that forms the particle surface on the surface of the carbon particle so that the surface of the carbon-modified particle be formed from a compound containing only a carbon atom and a hydrogen atom as constituent atoms or a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more. Specifically, it is preferable that the carbon-modified particle be obtained by surface-treating the carbon particle to dispose the surface portion that forms the particle surface on the surface of the carbon particle so that the particle surface of the resultant carbon-modified particle has the specific atom configuration.

FIG. 2 is a cross-sectional view schematically illustrating a colored particle for an electrowetting display (EWD) according to a second embodiment of the present invention.

The colored particle for an electrowetting display (EWD) shown in FIG. 2 is a carbon-modified particle for an EWD 31. The carbon-modified particle for an EWD 31 includes a carbon particle 32 and a surface portion 33 that is disposed on a surface of the carbon particle 32 and constitutes a particle surface. The surface portion 33 is preferably a surface layer. In the carbon-modified particle for an EWD 31, the particle surface is formed from a compound having the atom configuration as described above.

Dye-Containing Particle for an EWD:

It is preferable that the colored particle for an EWD include a substrate particle and a dye contained in the substrate particle, and a particle surface be formed from a compound containing only a carbon atom and a hydrogen atom as constituent atoms or a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more. In the preferred embodiment, the colored particle for an EWD is a dye-containing particle for an EWD or a black particle for an EWD.

A composition containing a dye and oil is conventionally used as an ink for an EWD. The dye has problems in which the light fastness and heat resistance are generally low, that is, the weather resistance is low. Therefore, when the composition containing a dye is used as an ink for an EWD, the dye is deteriorated, hue of viewing image of an EWD changes, and thus the viewing quality of the EWD may be deteriorated during use period. In particular, when the EWD is built outside, there is a serious problem of decrease in the viewing quality of the EWD.

A dye-containing particle in which a particle contains a dye is known. However, when the dye-containing particle is dispersed in a hydrophobic liquid in an ink for an EWD, there is a problem of low dispersibility of the dye-containing particle. In addition, there is a problem of use of a large amount of surfactant to enhance the dispersibility. In order to improve the viewing quality of an EWD in an ink for an EWD, it is desirable that the dispersibility of the dye-containing particle be high.

On the other hand, the dye-containing particle for an EWD has a particle surface formed from a compound having the specific atom configuration. Therefore, even when the dye is contained in a substrate particle, the weather resistance of the dye-containing particle for an EWD can be enhanced. Therefore, changes in hue of viewing image of an EWD and the like are unlikely to be caused, and the viewing quality of the EWD can be excellently maintained during use period. In particular, even when the EWD is built outside, the viewing quality of the EWD is unlikely to decrease. Further, the dispersibility of the dye-containing particle for an EWD in an ink for an EWD can be enhanced.

When a particle in which a substrate particle contains a dye does not have the specific particle surface and is dispersed in a hydrophobic solvent, the dye may be eluted in the hydrophobic solvent. For this reason, the hydrophobic solvent may be colorized unintentionally. As a result, there is a problem of deterioration in the viewing quality of an EWD during use period. In addition, when the amount of the dye in the substrate particle is decreased to suppress the elution of the dye, the hiding properties of the dye-containing particle are not sufficiently achieved in an ink for an EWD. In the dye-containing particle for an EWD, one of important requirements is to achieve sufficient hiding properties by sufficient coloration.

In contrast, the dye-containing particle for an EWD has the specific particle surface. Therefore, even when the dye is contained in the substrate particle, the dye is unlikely to be eluted in a hydrophobic solvent during dispersion of the particle in the hydrophobic solvent. For this reason, the viewing quality of an EWD can be excellently maintained during use period.

When the particle in which the substrate particle contains the dye has no specific particle surface, the dye generally has a polar group. Therefore, the dispersibility of the particle in which the substrate particle contains the dye in a hydrophobic solvent decreases.

In contrast, since the dye-containing particle for an EWD has the specific particle surface, the hydrophobicity of the particle surface can be sufficiently enhanced. Therefore, when the dye-containing particle for an EWD is used for an ink for an EWD, the dispersibility of the dye-containing particle for an EWD in an ink for an EWD can be enhanced.

A particle surface having the specific atom configuration is easily formed. Therefore, it is preferable that the dye-containing particle be obtained by using a dye-containing particle material that includes a substrate particle and a dye contained in the substrate particle, and surface-treating the dye-containing particle material so that the particle surface is formed from a compound containing only a carbon atom and a hydrogen atom as constituent atoms or a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more. Specifically, it is preferable that the dye-containing particle be obtained by surface-treating the dye-containing particle material so that the particle surface of the resultant dye-containing particle has the specific atom configuration.

FIG. 3 is a cross-sectional view schematically illustrating a colored particle for an electrowetting display (EWD) according to a third embodiment of the present invention.

The colored particle for an electrowetting display (EWD) shown in FIG. 3 is a dye-containing particle for an EWD 41. The dye-containing particle for an EWD 41 includes a dye-containing particle 42 and a surface portion 43 that is disposed on a surface of the dye-containing particle 42 and constitutes a particle surface. The surface portion 43 is preferably a surface layer. In the dye-containing particle for an EWD 41, the particle surface is formed from a compound having the atom configuration as described above.

Inorganic Pigment-Modified Particle for an EWD:

The colored particle for an EWD may include an inorganic pigment (particle) and a surface portion that is disposed on a surface of the inorganic pigment and constituents a particle surface that may be formed from a compound containing only a carbon atom and a hydrogen atom as constituent atoms or a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more. In this embodiment, the colored particle for an EWD is an inorganic pigment-modified particle, and preferably a black particle for an EWD. The inorganic pigment is preferably a black inorganic pigment.

A specific embodiment of a colored particle for an EWD containing an inorganic pigment is not shown in the drawings, but the inorganic pigment-modified particle is obtained, for example, by using an inorganic pigment instead of the carbon particle 32 in FIG. 2.

Other Details of Colored Particle for an EWD:

It is preferable that the colored particle for an EWD have a surface formed from the first compound. Further, it is preferable that the colored particle for an EWD have a surface formed from the second compound.

In the colored particle for an EWD according to the present invention, the dispersibility of the colored particle for an EWD can be enhanced even when the addition amount of surfactant to an ink for an EWD is small or the surfactant is not added to the ink for an EWD. When the surfactant is not used in the ink for an EWD or the addition amount of the surfactant is small, the driving response of an EWD in the ink for an EWD is further improved.

The whole region of the surface of the colored particle for an EWD according to the present invention may not be a surface that is formed from a compound having the atom configuration as described above. The ratio of the surface area of the surface formed from a compound having the atom configuration to the whole area of the surface of the colored particle for an EWD is preferably 50% or more, more preferably 80% or more, further preferably 90% or more, particularly preferably 95% or more, and the most preferably 99% or more. As a portion of particle surface formed from a compound having the atom configuration is larger, the hydrophobicity of surface of the colored particle for an EWD increases, and the dispersibility of the colored particle for an EWD further increases. As the portion of particle surface formed from a compound having the atom configuration is larger, the weather resistance of the dye-containing particle for an EWD further increases. As the portion of particle surface formed from a compound having the atom configuration is larger, the conductivity of the carbon-modified particle for an EWD further decreases.

A particle surface having the specific atom configuration is easily formed. Therefore, it is preferable that the colored particle for an EWD have a core and a shell that coats a surface of the core. It is preferable that the colored particle for an EWD be a core-shell particle.

It is preferable that the carbon-modified particle for an EWD, the dye-containing particle for an EWD, and the inorganic pigment-modified particle for an EWD each have a core and a shell that coats a surface of the core. It is preferable that the carbon-modified particle for an EWD, the dye-containing particle for an EWD, and the inorganic pigment-modified particle for an EWD be each a core-shell particle. It is preferable that the core be the carbon particle. It is preferable that the core be the substrate particle. It is preferable that the dye be contained in the core. It is preferable that the core be the inorganic pigment. It is preferable that the shell be the surface portion.

The average particle diameter of the colored particle for an EWD is preferably 20 nm or more, more preferably 40 nm or more, and further preferably 50 nm or more, and preferably 300 nm or less and more preferably 250 nm or less. When the average particle diameter is equal to or more than the lower limit or equal to or less than the upper limit, the hiding properties of the colored particle are further enhanced, the dispersion stability of the colored particle in the ink is further enhanced, and the flowability of the colored particle in the ink is further enhanced. The average particle diameter of the colored particle for an EWD may be 100 nm or more.

The average particle diameter means a particle diameter at which the integrated value in a particle size distribution in terms of volume determined with a dynamic light scattering particle size distribution analyzer is 50%.

The specific gravity of the colored particle for an EWD is preferably 3 or less, and more preferably 2 or less. When the specific gravity is equal to or less than the upper limit, the dispersion stability of the colored particle in the ink is further enhanced.

In order to further improve the viewing quality of an EWD using the colored particle for an EWD, it is preferable that the colored particle for an EWD be spherical. The average aspect ratio of a spherical colored particle for an EWD is 1.5 or less. It is preferable that the average aspect ratio of the colored particle for an EWD be 1.5 or less. The aspect ratio is a ratio of a longer diameter to a shorter diameter (longer diameter/shorter diameter). When the average aspect ratio is equal to or less than the upper limit, light is likely to be isotropically scattered by the colored particle, and a better viewing image can be obtained.

Hereinafter, each component used in formation of the colored particle for an EWD will be described.

[Polymerizable compound, substrate particle such as polymer substrate particle, carbon particle, and inorganic pigment]

It is preferable that the colored particle for an EWD be obtained by polymerization of a polymerizable compound that forms a π-conjugated polymer by polymerization. By this polymerization reaction, the polymer substrate particle can be obtained. The polymerizable compound may be used alone or in combination of two or more kinds thereof.

It is preferable that the polymerizable compound be a monomer or an oligomer having a molecular weight of 1,000 or less. The molecular weight of the oligomer is preferably 500 or less. Specific examples of the polymerizable compound may include furan, pyrrole, thiophene, acetylene, and a derivative thereof. The derivative has a furan skeleton, a pyrrole skeleton, a thiophene skeleton, or an acetylene skeleton. The polymerizable compound may be a dimer to a tetramer. Another polymerizable compound may be used.

Specific examples of the π-conjugated polymer may include polyfuran, polypyrrole, polythiophene, polyacetylene, and a derivative thereof. The derivative has a polyfuran skeleton, a polypyrrole skeleton, a polythiophene skeleton, or a polyacetylene skeleton. Another π-conjugated polymer may be used. The π-conjugated polymer may be a polymer obtained by oxidative polymerization of the polymerizable compound as a starting material.

In order to further enhance polymerization properties and handleability, it is preferable that the polymerizable compound be pyrrole, a derivative of pyrrole, thiophene, or a derivative of thiophene, and more preferably pyrrole, thiophene, or poly-3,4-ethylenedioxythiophene (PEDOT).

The polymer substrate particle may have a state in which an organic particle, an inorganic particle except for a metal particle, a metal particle, or a composite particle thereof is contained in the inside of the polymer substrate particle by polymerization of the polymerizable compound in the presence of the organic particle, the inorganic particle except for a metal particle, the metal particle, or the composite particle thereof. It is preferable that a particle used in the polymerization of the polymerizable compound be an organic particle.

Examples of a resin constituting the organic particle may include a polyolefine resin, an acrylic resin, a phenolic resin, a melamine resin, a benzoguanamine resin, an urea resin, an epoxy resin, an unsaturated polyester resin, a saturated polyester resin, polyethylene terephthalate, polysulfone, polyphenylene oxide, polyacetal, polyimide, polyamide imide, polyether ether ketone, polyether sulfone, a divinylbenzene polymer, and a divinylbenzene-based copolymer. Examples of the divinylbenzene-based copolymer may include a divinylbenzene-styrene copolymer, and a divinylbenzene-(meth)acrylate copolymer. The resin constituting the organic particle may be used alone or in combination of two or more kinds thereof.

The carbon particle is generally black, and is a black particle. Examples of a carbon material constituting the carbon particle may include carbon black, carbon nanotube, fullerene, graphene, and graphite. It is preferable that the carbon material be carbon black. Examples of the carbon black may include ketjen black, acetylene black, channel black, thermal black, and furnace black.

The substrate particle to contain a dye is not particularly limited as long as it can contain the dye. Examples of the substrate particle may include an organic particle, an inorganic particle except for metal, and an organic and inorganic composite particle. It is preferable that the substrate particle be an organic particle, and preferably a resin particle. The resin particle is formed from a resin.

Examples of a resin to form the organic particle and the resin particle may include a polymer of a polymerizable monomer such as an olefin such as ethylene, propylene, butadiene, butylene, and methylpentene, and a derivative thereof; a styrene derivative such as styrene, α-methylstyrene, p-methylstyrene, p-chlorostyrene, divinylbenzene, and chloromethylstyrene; vinyl fluoride; vinyl chloride; a vinyl ester such as vinyl acetate and vinyl propionate; a vinyl ether such as methyl vinyl ether; an unsaturated nitrile such as acrylonitrile; a (meth)acrylate derivative such as methyl (meth)acrylate, ethyl (meth)acrylate, butyl (meth)acrylate, 2-ethylhexyl (meth)acrylate, stearyl (meth)acrylate, ethylene glycol (meth)acrylate, trifluoroethyl (meth)acrylate, pentafluoropropyl (meth)acrylate, and cyclohexyl (meth)acrylate; dicarboxylic acid such as phthalic acid; diamine; diallyl phthalate; benzoguanamine; triallyl isocyanate; and a condensate and a polymer that mainly contain polyether such as polyethylene glycol and polypropylene glycol, polyvinyl alcohol, polyacetal, an allyl resin, a furan resin, a silicone resin, polyurethane, a fluororesin, a vinyl resin, polycarbonate, polyamide, (un)saturated polyester, polyethylene terephthalate, polysulfone, polyphenylene oxide, polyimide, polyamide imide, polyether ether ketone, polyether sulfone, an epoxy resin, a phenolic resin, a melamine resin, sugar, starch, cellulose, or polypeptide. The polymerizable monomer may be used alone or in combination of two or more kinds thereof. The resin to form the organic particle and the resin particle may be used alone or in combination of two or more kinds thereof. Since the hardnesses of the organic particle and the resin particle can be easily controlled to a suitable range, it is preferable that the resin to form the organic particle and the resin particle be a polymer obtained by polymerization of one or more kinds of polymerizable monomer having an ethylenically unsaturated group.

It is preferable that the substrate particle to contain a dye be obtained by polymerization of a polymerizable compound that forms a π-conjugated polymer by polymerization. In this case, the polymerizable compound may be used alone or in combination of two or more kinds thereof.

Examples of an inorganic material constituting the inorganic pigment may include black titanium, black iron oxide, and silicon carbide.

[Surface-Forming Material]

It is preferable that the colored particle for an EWD be obtained by polymerization of the polymerizable compound using a surface-forming material. The surface-forming material may be an organic dispersant. It is preferable that the colored particle for an EWD be obtained by polymerization of the polymerizable compound using the organic dispersant. It is preferable that the carbon-modified particle for an EWD be obtained using the carbon particle and the surface-forming material. It is preferable that the dye-containing particle for an EWD be obtained using the substrate particle containing the dye (dye-containing particle material) and the surface-forming material. The particle surface having the specific atom configuration is easily formed by use of the surface-forming material such as the organic dispersant. The surface-forming material may be used alone or in combination of two or more kinds thereof.

In order to effectively enhance the dispersibility of the colored particle for an EWD, it is preferable that the surface of the colored particle for an EWD be formed from the surface-forming material. It is preferable that a compound of surface of the colored particle for an EWD be a compound derived from the surface-forming material. In order to effectively enhance the dispersibility of the colored particle for an EWD, it is preferable that the colored particle for an EWD have a core derived from the polymerizable compound (π-conjugated polymer), and a shell that coats a surface of the core and is derived from the surface-forming material.

It is preferable that the surface portion of the carbon-modified particle for an EWD be formed from the surface-forming material. It is preferable that a compound constituting the surface portion of the carbon-modified particle for an EWD be a compound derived from the surface-forming material. In order to effectively enhance the dispersibility of the carbon-modified particle for an EWD, it is preferable that the carbon-modified particle for an EWD have the carbon particle, and a shell that coats a surface of the carbon particle and is derived from the surface-forming material. It is preferable that the shell be the surface portion.

In order to effectively enhance the weather resistance, resistance to dye elution, and dispersibility of the dye-containing particle for an EWD, it is preferable that the surface of the dye-containing particle for an EWD be formed from the surface-forming material and the surface portion be formed from the surface-forming material. It is preferable that the compound of the surface of the dye-containing particle for an EWD be a compound derived from the surface-forming material and the compound constituting the surface portion be formed from the surface-forming material. In order to effectively enhance the weather resistance, resistance to dye elution, and dispersibility of the dye-containing particle for an EWD, it is preferable that the dye-containing particle for an EWD have the substrate particle, and a shell that coats a surface of the substrate particle and is derived from the surface-forming material. It is preferable that the dye-containing particle for an EWD have a core derived from the dye-containing particle, and a shell that coats a surface of the core and is derived from the surface-forming material. It is preferable that the shell be the surface portion. It is preferable that a compound constituting the surface portion in the inorganic pigment particle for an EWD be a compound derived from the surface-forming material.

Specific examples of the surface-forming material and the organic dispersant may include a long-chain hydrocarbon such as polyethylene, polypropylene, and polyisobutylene, a polymer of alkyl (meth)acrylate having an alkyl group having 12 to 18 carbon atoms, a polymer of a diene compound and a hydrogenated product thereof, an isobutene-isoprene copolymer, a styrene-butadiene copolymer, a styrene-isoprene copolymer, an isoprene-vinyl pyridine copolymer, an isoprene-acrylic acid copolymer, a butadiene-acrylonitrile copolymer, a polymer of alkyl vinyl ether having an alkyl group having 12 to 18 carbon atoms, a copolymer of α-olefin with alkyl vinyl ether, and a copolymer of α-olefin with a diene compound. Examples of the diene compound may include isoprene and butadiene. Examples of the α-olefin may include 1-butene, 1-pentene, 1-hexene, and 1-octene. Another surface-forming material may be used.

In order to further enhance the dispersibility of the colored particle for an EWD, it is preferable that in the surface-forming material, constituent atoms be only a carbon atom and a hydrogen atom, or the total amount of a carbon atom, a hydrogen atom, an oxygen atom, a nitrogen atom, and a sulfur atom be 95% by mass or more relative to 100% by mass of total of constituent atoms, and the mass ratio of the amount of the carbon atom to the total amount of the oxygen atom, the nitrogen atom, and the sulfur atom be 5 or more. When the surface-forming material contains a carbon atom, a hydrogen atom, an oxygen atom, a nitrogen atom, and a sulfur atom, it is preferable that the mass ratio of the amount of the carbon atom to the total amount of the oxygen atom, the nitrogen atom, and the sulfur atom in the surface-forming material be 5 or more.

In order to further enhance the dispersibility of the colored particle for an EWD, it is preferable that the surface-forming material be a polymer of a polymerization component containing at least one selected from the group consisting of styrene, isoprene, isobutylene, 1-butene, 1-pentene, 1-hexene, 1-octene, and butadiene or a hydrogenated product of the polymer, or a polymer of alkyl (meth)acrylate having an alkyl group having 12 to 18 carbon atoms. It is preferable that the surface-forming material be a polymer of a polymerization component containing at least one selected from the group consisting of styrene, isoprene, isobutylene, 1-butene, 1-pentene, 1-hexene, 1-octene, and butadiene, a hydrogenated product of the polymer, or a polymer of alkyl (meth)acrylate having an alkyl group having 12 to 18 carbon atoms. It is preferable that constituent atoms of the polymer of a polymerization component containing at least one selected from the group consisting of styrene, isoprene, isobutylene, 1-butene, 1-pentene, 1-hexene, 1-octene, and butadiene be only a carbon atom and a hydrogen atom. It is preferable that constituent atoms of the hydrogenated product of the polymer be only a carbon atom and a hydrogen atom. It is preferable that the total amount of a carbon atom, a hydrogen atom, an oxygen atom, a nitrogen atom, and a sulfur atom be 95% by mass or more relative to 100% by mass of total of constituent atoms of the polymer of alkyl (meth)acrylate having an alkyl group having 12 to 18 carbon atoms. It is preferable that the mass ratio of the amount of the carbon atom to the total amount of the oxygen atom, the nitrogen atom, and the sulfur atom in the polymer of alkyl (meth)acrylate having an alkyl group having 12 to 18 carbon atoms be 5 or more. The surface-forming material may be a polymer of a polymerization component containing at least one selected from the group consisting of isoprene, isobutylene, 1-butene, 1-pentene, 1-hexene, 1-octene, and butadiene or a hydrogenated product of the polymer. The polymer of a polymerization component containing at least one selected from the group consisting of styrene, isoprene, isobutylene, 1-butene, 1-pentene, 1-hexene, 1-octene, and butadiene or a hydrogenated product of the polymer may be a polymer of a polymerization component containing at least one selected from the group consisting of styrene, isoprene, isobutylene, and butadiene or a hydrogenated product of the polymer.

In order to effectively enhance the dispersibility of the colored particle for an EWD, it is preferable that the surface-forming material be a surface-forming material that is an organic macromolecule. The weight average molecular weight of the organic macromolecule surface-forming material is preferably 10,000 or more, and preferably 1,000,000 or less. It is preferable that the weight average molecular weight of the organic macromolecule surface-forming material that forms the surface of the colored particle for an EWD be equal to or more than the lower limit and equal to or less than the upper limit.

The weight average molecular weight shows a weight average molecular weight in terms of polystyrene determined by gel permeation chromatography (GPC). Examples of a column used in GPC measurement may include “Shodex LF-804®” available from Showa Denko K.K.

It is preferable that the surface-forming material be soluble in a hydrophobic solvent described below in order to easily form the surface of the colored particle for an EWD from the surface-forming material.

The amount of the surface-forming material to be used in polymerization of the polymerizable compound is not particularly limited. For example, the use amount of the surface-forming material is preferably 0.05 parts by mass or more, more preferably 0.1 parts by mass or more, and further preferably 0.5 parts by mass or more, and preferably 500 parts by mass or less, and more preferably 100 parts by mass or less, relative to 100 parts by mass of the polymerizable compound. The use amount of the surface-forming material may be 10 parts by mass or less, or 5 parts by mass or less.

When the surface portion is formed on the surface of the carbon particle and the inorganic pigment or the carbon particle and the inorganic pigment are surface-treated, the use amount of the surface-forming material is not particularly limited. The use amount of the surface-forming material will be described. It is preferably 0.05 parts by mass or more, more preferably 0.1 parts by mass or more, and further preferably 0.5 parts by mass or more, and preferably 500 parts by mass or less, and more preferably 100 parts by mass or less, relative to 100 parts by mass of the carbon particle or 100 parts by mass of the inorganic pigment.

When the surface portion is formed on the surface of the substrate particle or the substrate particle is surface-treated, the use amount of the surface-forming material is not particularly limited. For example, the use amount of the surface-forming material is preferably 0.05 parts by mass or more, more preferably 0.1 parts by mass or more, and further preferably 0.5 parts by mass or more, and preferably 500 parts by mass or less, and more preferably 100 parts by mass or less, relative to 100 parts by mass of the substrate particle.

[Dye]

As the dye, a dye having an appropriate hue that is required for the dye-containing particle for an EWD is used.

As the dye, a dye soluble in an organic solvent is preferably used. Examples thereof may include an azo-based dye, an anthraquinone-based dye, a triallylmethane-based dye, a phthalocyanine-based dye, a quinoline-based dye, a styryl-based dye, an indoaniline-based dye, and a methine-based dye.

Specific examples of the dye may include Solvent Black 3, 5, and 7, Solvent Yellow 16, Solvent Yellow 29, Solvent Yellow 33, Disperse Yellow 201, Solvent Orange 77, Solvent Red 19, 122, 130, and 233, Solvent Red 27, 168, and 207, Disperse Violet 26, Solvent Bule 63, 67, 70, 95, and 136, and Solvent Blue 5, 35, and 45, which are general dyes.

Examples of dyes available from NIPPON KAYAKU Co., Ltd. may include Kayaset Black K-R, and A-N, Kayalon Polyester Black S-200, EX-SF300, G-SF, BR-SF, 2B-SF200, TA-SF200, and AUL-S, Kayaset Yellow K-CL, Kayalon Polyester Yellow 4G-E, Kayalon Polyester Light Yellow 5G-S, Kayaset Red K-BL, Kayacelon Red E-BF, SMS-5, and SMS-12, Kayalon Polyester Red TL-SF, BR-S, BL-E, HL-SF, 3BL-S200, and AUL-S, Kayalon Polyester Light Red B-S200, Kayalon Polyester Rubine BL-5200, Kayaset Blue N, K-FL, and MSB-13, Kayalon Polyester Blue BR-SF, and T-S, Kayalon Polyester Light Blue BGL-5200, Kayalon Polyester Turq Blue GL-5200, and Kayalon Polyester Blue Green FCT-S.

Examples of dyes available from ORIENT CHEMICAL INDUSTRIES CO., LTD. may include Valifast Black 3806, 3810, and 3820, Oil Black BS, BY, B-85, and 860, Water Yellow 6C, Valifast Yellow 1101, 1105, 3110, 3120, 4120, and 4126, Oplas Yellow 130, and 140, Oil Yellow GG-S, 105, 107, 129, and 818, Water Red 27, Valifast Red 1306, 1355, 2303, 3311, and 3320, Valifast Orange 3210, Valifast Brown 2402, Oil Red 5B, Oil Pink 312, Oil Brown BB, Valifast Blue 1601, 1603, 1605, 2606, 3806, and 3820, and Oil Blue #15, #613, 613, N14, and BOS.

Examples of dyes available from Sumitomo Chemical Co., Ltd. may include Sumikaron Black S-BL, S-BE extra conc., S-RPD, and S-XE 300%, Sumikaron Yellow SE-4G, SE-5G, SE-3GL conc., and SE-RPD, Sumikaron Brilliant Flavine S-10G, Sumikaron Red E-FBL, E-RPD (E), and S-RPD (S), Sumikaron Brilliant Red S-BF, S-BLF, SE-BL, SE-BGL, SE-2BF, and SE-3BL (N), Sumikaron Red E-FBL, E-RPD (E), and S-RPD (S) Sumikaron Brilliant Red S-BF, S-BLF, SE-BL, SE-BGL, SE-2BF, and SE-3BL (N) Sumikaron Brilliant Blue S-BL, and Sumikaron TurquoiseBlue S-GL, and S-GLFgrain.

Examples of dyes available from BASF may include Basacryl Black X-BGW, Naozapon Black X-51, and X-55, Neozapon Yellow 081, Lurafix Yellow 138, Zapon Blue 807, Neozapon Blue 807, and Lurafix Blue 590, and 660.

Examples of dyes available from Taoka Chemical Co., Ltd. may include Oleosol FastBlack AR, and RL, Oleosol Fast Pink FB, Rhodamine A, B, and B gran., Oleosol Fast Yellow 2G, and Oleosol Fast Blue ELN.

Examples of dyes available from HODOGAYA CHEMICAL Co., Ltd. may include Spilon Black BNH, and MH special.

Examples of dyes available from Ciba may include Orasol Black RLI, RL, and CN, Oracet Yellow 8GF, and GHS, Orasol Red G, Oracet Pink RP, and Orasol Blue GL, GN, and 2R.

Examples of dyes available from Mitsui Toatsu Chemicals, Inc. may include PS Yellow GG, MS Yellow HD-180, PS Red G, and MS Magenta VP.

Examples of dyes available from Bayer Corp. may include Ceres Blue GN 01.

Examples of dyes available from SUMIKA COLOR CO., LTD. may include TS Yellow 118 cake, ESC Yellow 155, Sumiplast Yellow HLR, and GC, TS Turq Blue 618, and 606, ESC Blue 655, and 660, and Sumiplast Blue S, and OA.

A pyrazole disazo-based dye shown in JP-A-2009-138189 or an anthraquinone-based or naphthoquinone-based dye shown in JP-T-2012-503056 can be used.

The dye can be appropriately selected depending on a composition of core particles or the like, and may be used alone or in combination of two or more kinds thereof.

A method for containing the dye in the substrate particle is not particularly limited. Examples of the method for containing the dye in the substrate particle may include a method for immersing the substrate particle in a solution containing the dye, a method for adding the dye to a reaction solution during preparation of the substrate particle from the polymerizable monomer or the like, a method in which the resin constituting the substrate particle and the dye are dissolved in a water-soluble organic solvent, and water is added, resulting in emulsification, and a method in which the resin constituting the substrate particle and the dye are dissolved in a hydrophobic organic solvent, an emulsion is formed in water, and the organic solvent is removed (in-liquid drying method).

The use amount of the dye to be contained in the substrate particle is not particularly limited. The use amounts of the substrate particle and the dye will be described. The use amount of the dye is preferably 5 parts by mass or more, and more preferably 10 parts by mass or more, and preferably 200 parts by mass or less, and more preferably 100 parts by mass or less, relative to 100 parts by mass of the substrate particle.

The use amounts of the polymerizable compound and the dye are not particularly limited during polymerization of the polymerizable compound. The use amounts of the polymerizable compound and the dye will be described. The use amount of the dye is preferably 3 parts by mass or more, and more preferably 5 parts by mass or more, and preferably 200 parts by mass or less, and more preferably 100 parts by mass or less, relative to 100 parts by mass of the polymerizable compound.

[Solvent]

The colored particle for an EWD may be obtained by polymerization of the polymerizable compound in a hydrophobic solvent in the presence of the surface-forming material or the organic dispersant, or by polymerization of the polymerizable compound in a hydrophilic solvent, followed by surface treatment in a hydrophobic solvent. It is preferable that the colored particle for an EWD be obtained by polymerization of the polymerizable compound in a hydrophobic solvent.

It is preferable that the carbon-modified particle for an EWD be obtained by disposing the surface portion on a surface of the carbon particle in a hydrophobic solvent. It is preferable that the carbon-modified particle for an EWD be obtained by surface treatment of the carbon particle in a hydrophobic solvent.

It is preferable that the dye-containing particle for an EWD be obtained by surface treatment of the substrate particle in a hydrophobic solvent. It is preferable that the dye-containing particle for an EWD be obtained by surface treatment of substrate particle containing the dye in a hydrophobic solvent.

It is preferable that the inorganic pigment-modified particle for an EWD be obtained by disposing the surface portion on a surface of the inorganic pigment particle in a hydrophobic solvent. It is preferable that the inorganic pigment-modified particle for an EWD be obtained by surface treatment of the inorganic pigment particle in a hydrophobic solvent.

Examples of the hydrophilic solvent may include water and alcohols. A hydrophilic solvent other than water is compatible with water. Water is included in the hydrophilic solvent. The hydrophilic solvent may be used alone or in combination of two or more kinds thereof.

The hydrophobic solvent is not compatible with water. The compatibility of the hydrophobic solvent with water can be determined by the presence or absence of separation of the hydrophobic solvent and water during mixing of 100 mL of water with 100 mL of the solvent at normal temperature (23° C.). The hydrophobic solvent may be used alone or in combination of two or more kinds thereof.

Since the hydrophobic solvent is not compatible with water, it is preferable that a SP value of the hydrophobic solvent be 9 or less. The colored particle for an EWD having more excellent dispersibility is obtained using a hydrophobic solvent having high hydrophobicity, and the dispersibility of the colored particle in an ink further increases.

The SP value (solubility parameter) can be calculated through Fedors method (R. F. Fedors, Polym. Eng. Sci., 14, 147 (1974)).

Specific examples the hydrophobic solvent may include octane (SP value: 7.5), nonane (SP value: 7.5), decane (SP value: 7.6), undecane (SP value: 7.6), dodecane (SP value: 7.7), toluene (SP value: 8.8), and xylene (SP value: 8.8). Another hydrophobic solvent may be used.

The use amounts of the polymerizable compound and the solvent are not particularly limited during polymerization of the polymerizable compound. The use amounts of the polymerizable compound and the solvent will be described. The use amount of the polymerizable compound is preferably 0.05% by mass or more, and more preferably 0.5% by mass or more, and preferably 10% by mass or less, and more preferably 5% by mass or less, relative to the total amount of the polymerizable compound and the solvent of 100% by mass.

When the surface portion is formed on the surface of the carbon particle and the inorganic pigment or the carbon particle and the inorganic pigment are surface-treated, the use amounts of the carbon particle, the inorganic pigment, and the hydrophobic solvent are not particularly limited. The use amounts of the carbon particle or the inorganic pigment and the hydrophobic solvent will be described. The use amount of the carbon particle or the inorganic pigment is preferably 0.05% by mass or more, and more preferably 0.5% by mass or more, and preferably 10% by mass or less, and more preferably 5% by mass or less, relative to the total amount of the carbon particle or the inorganic pigment and the hydrophobic solvent of 100% by mass.

When the surface portion is formed on the surface of the substrate particle or the substrate particle is surface-treated, the use amounts of the substrate particle and the hydrophobic solvent are not particularly limited. The use amounts of the substrate particle and the hydrophobic solvent will be described. The use amount of the substrate particle is preferably 0.05% by mass or more, and more preferably 0.5% by mass or more, and preferably 10% by mass or less, and more preferably 5% by mass or less, relative to the total amount of the substrate particle and the hydrophobic solvent of 100% by mass.

[Oxidative Polymerization Initiator]

It is preferable that an oxidative polymerization initiator be generally used during polymerization of the polymerizable compound. Examples of the oxidative polymerization initiator may include an organic peroxide and an organometallic compound. The oxidative polymerization initiator may be used alone or in combination of two or more kinds thereof.

The use amount of the oxidative polymerization initiator will be described. The use amount of the oxidative polymerization initiator is preferably 0.01 mol or more, more preferably 0.1 mol or more, and further preferably 1 mol or more, and preferably 10 mol or less, more preferably 5 mol or less, and further preferably 3 mol or less, relative to 1 mol of the polymerizable compound.

The organic peroxide may be used alone or in combination of two or more kinds thereof. Examples of the organic peroxide may include a diacyl peroxide compound, a peroxy ester compound, a hydroperoxide compound, a peroxy carbonate compound, a peroxy ketal compound, a dialkyl peroxide compound, and a ketone peroxide compound. It is preferable that the organic peroxide be soluble in the hydrophobic solvent.

Examples of the diacyl peroxide compound may include benzoyl peroxide, diisobutyryl peroxide, di(3,5,5-trimethyl hexanoyl) peroxide, dilauroyl peroxide, diisononanoyl peroxide, and disuccinic acid peroxide. Examples of the peroxy ester compound may include cumyl peroxyneodecanoate, 1,1,3,3-tetramethylbutyl peroxyneodecanoate, tert-hexyl peroxyneodecanoate, tert-butyl peroxyneodecanoate, tert-butyl peroxyneoheptanoate, tert-hexyl peroxypivalate, 1,1,3,3-tetramethylbutyl peroxy-2-ethylhexanoate, 2,5-dimethyl-2,5-di(2-ethylhexanoyl peroxy)hexane, tert-hexyl peroxy-2-ethylhexanoate, tert-butyl peroxypivalate, tert-amyl peroxy-2-ethylhexanoate, tert-butyl peroxy-2-ethylhexanoate, tert-butyl peroxyisobutyrate, tert-butyl peroxylaurate, tert-butyl peroxyisophthalate, tert-butyl peroxyacetate, tert-butyl peroxyoctoate, and tert-butyl peroxybenzoate. Examples of the hydroperoxide compound may include cumene hydroperoxide, and p-menthane hydroperoxide. Examples of the peroxy carbonate compound may include di(2-ethylhexyl) peroxydicarbonate, di(sec-butyl) peroxydicarbonate, di-n-propyl peroxydicarbonate, diisopropyl peroxydicarbonate, di(4-tert-butylcyclohexyl) peroxydicarbonate, and tert-butyl peroxy-2-ethylhexylcarbonate. Examples of the peroxy ketal compound may include 1,1-di-tert-butyl peroxychlorohexane. Examples of the dialkyl peroxide compound may include di-tert-butyl peroxide. Additional examples of the peroxide may include methyl ethyl ketone peroxide, potassium persulfate, and 1,1-bis(tert-butyl peroxy)-3,3,5-trimethyl cyclohexane.

It is preferable that the organic peroxide be soluble in the hydrophobic solvent in order to further enhance an addition effect of the organic peroxide, and more easily obtain the colored particle for an EWD.

The amount of the organic peroxide to be used in polymerization of the polymerizable compound is not particularly limited. The use amount of the organic peroxide will be described. The use amount of the organic peroxide is preferably 0.01 mol or more, more preferably 0.1 mol or more, and further preferably 1 mol or more, and preferably 10 mol or less, more preferably 5 mol or less, and further preferably 3 mol or less, relative to 1 mol of the polymerizable compound.

The organometallic compound may be used alone or in combination of two or more kinds thereof. Examples of metal constituting the organometallic compound may include metals of group 6 to 12 and 4th to 6th periods in the periodic table. In particular, iron, copper, and ruthenium are suitable since they are industrially inexpensive and have high safety. Examples of the organometallic compound may include a solvate that is a solvent in which a metal salt can be dissolved, an organometallic complex in which a ligand such as fenocene, phthalocyanine, and bipyridine is coordinated, and an organometallic salt that is bonded to a counter ion having an alkyl chain or the like.

The organometallic compound may be dissolved in a solvent in which the organometallic compound can be dissolved and used.

The amount of the organometallic compound to be used in polymerization of the polymerizable compound is not particularly limited. The use amount of the organometallic compound will be described. The use amount of the organometallic compound is preferably 0.01 mol or more, more preferably 0.1 mol or more, and further preferably 1 mol or more, and preferably 10 mol or less, more preferably 5 mol or less, and further preferably 3 mol or less, relative to 1 mol of the polymerizable compound. When the organic peroxide and the organometallic compound are used in combination, the use amount of the organometallic compound is preferably 0.01 mol or more, more preferably 0.1 mol or more, and further preferably 0.5 mol or more, and preferably 10 mol or less, more preferably 3 mol or less, and further preferably 1 mol or less, relative to 1 mol of the polymerizable compound. The use amount of the organometallic compound is preferably 1 mol or less, more preferably 0.1 mol or less, and further preferably 0.01 mol or less relative to 1 mol of the polymerizable compound.

It is preferable that an oxidative polymerization initiator soluble in the hydrophilic solvent be used during polymerization of the polymerizable compound in the hydrophilic solvent. Examples of the oxidative polymerization initiator may include peroxodisulfate such as alkali metal peroxodisulfate and ammonium peroxodisulfate, peroxocarbonate, alkali metal peroxocarbonate, and a transition metal salt such as iron sulfate, copper sulfate, iron chloride, copper chloride, iron sulfate, and copper sulfate.

[Additional Component]

A dopant of π-conjugated polymer, an acid-base modifier, or a surfactant may be used during polymerization of the polymerizable compound in the hydrophobic solvent. The acid-base modifier or the surfactant may be used during surface treatment of the substrate particle.

Specific examples of the surfactant may include sodium di(2-ethylhexyl)sulfosuccinate, and alkylbenzenesulfonate.

An additive or the like can be appropriately used to enhance the stability during polymerization of the polymerizable compound in the hydrophilic solvent. Examples of the additive may include a dispersion stabilizer such as polyacrylic acid, polyvinylpyrrolidone, and polyvinyl alcohol, and a surfactant such as sodium dodecylsulfate, hexadecyltrimethylammonium bromide, and polyoxyethylene lauryl ether. Further, the dopant of π-conjugated polymer, or the acid-base modifier may be used during polymerization of the polymerizable compound. In addition, the polymerizable compound may be polymerized in the presence of an inorganic fine particle, an organic fine particle, or an organic and inorganic composite fine particle.

[Method for Producing Colored Particle for an EWD]

In a method for producing the polymer particle for an EWD that is one example of the method for producing the colored particle for an EWD, the polymerizable compound is polymerized to obtain the colored particle for an EWD having a particle surface that is formed from a compound having the specific atom configuration (First production method).

A method for producing the carbon-modified particle for an EWD that is one example of the method for producing the colored particle for an EWD includes a step of surface-treating the carbon particle to dispose a surface portion that constitutes a surface of the particle on a surface of the carbon particle, obtaining the colored particle for an EWD (carbon-modified particle for an EWD) of which the surface is formed from a compound containing only a carbon atom and a hydrogen atom as constituent atoms or a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more (Second production method).

A method for producing the dye-containing particle for an EWD that is one example of the method for producing the colored particle for an EWD includes a step of surface-treating the dye-containing particle material that contains the substrate particle and a dye within the substrate particle to obtain the dye-containing particle for an EWD of which the surface is formed from a compound containing only a carbon atom and a hydrogen atom as constituent atoms or a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more (third production method). The method for producing the dye-containing particle for an EWD may include a step of containing a dye in the substrate particle to obtain the colored particle for an EWD having the substrate particle and the dye contained in the substrate particle (dye-containing particle material).

As a method for producing the inorganic pigment-modified particle for an EWD that is one example of the method for producing the colored particle for an EWD, there is a method that is the same as the first production method except that “carbon particle” is changed to “inorganic pigment” (forth production method).

It is preferable that the method for producing the colored particle for an EWD be the first, second, third, or forth production method, and more preferably the first, second, or third production method. In order to efficiently obtain a colored particle for an EWD having more excellent dispersibility, it is preferable that the polymerizable compound be polymerized using the surface-forming material to obtain the colored particle for an EWD, and it is more preferable that the polymerizable compound be polymerized using the organic dispersant to obtain the colored particle for an EWD. In order to efficiently obtain the colored particle for an EWD having more excellent dispersibility, it is preferable that the polymerizable compound be polymerized in the hydrophobic solvent to obtain the colored particle for an EWD. It is also preferable that the polymer substrate particle obtained by polymerization of the polymerizable compound in the hydrophilic solvent, the hydrophobic solvent, and the surface-forming material be used to obtain the colored particle for an EWD.

In order to efficiently obtain a carbon-modified particle for an EWD having more excellent dispersibility, it is preferable that the carbon particle and the hydrophobic solvent be used to obtain the carbon-modified particle for an EWD, and it is more preferable that the carbon particle, the hydrophobic solvent, and the surface-forming material be used to obtain the carbon-modified particle for an EWD.

The reaction temperature during polymerization of the polymerizable compound is preferably 0° C. or higher, and preferably 40° C. or lower, more preferably 30° C. or lower, and further preferably 25° C. or lower. The polymerization time during polymerization of the polymerizable compound is preferably 10 minutes or more, more preferably 1 hour or more, and further preferably 12 hours or more, and preferably 168 hours or less, more preferably 48 hours or less, and further preferably 24 hours or less.

The surface-forming material may be used during formation of the colored particle for an EWD. After a core (particle (substrate particle such as polymer substrate particle, carbon particle, inorganic pigment, etc.)) is obtained, a surface of the core may be coated with the surface-forming material or the like one time or several times. Examples of a coating method may include a coating method of adsorbing the surface-forming material to the surface of the core, a graft reaction method of chemically bonding the surface-forming material to the surface of the core, and a graft polymerization method of polymerizing a monomer to form the surface-forming material on the surface of the core.

When the polymerizable compound, the hydrophobic solvent, and the organic peroxide are used, it is preferable that the hydrophobic solvent and the polymerizable compound be mixed and the organic peroxide be then added. It is preferable that the organic peroxide be added in a small amount several times and that the organic peroxide be diluted and added to the hydrophobic solvent.

(Ink for Electrowetting)

An ink for an EWD according to the present invention contains the colored particle for an EWD and the hydrophobic solvent. The hydrophobic solvent may be used alone or in combination of two or more kinds thereof.

Examples of the hydrophobic solvent usable in the ink for an EWD may include a solvent that is the same as the hydrophobic solvent usable in polymerization of the polymerizable compound and a solvent that is the same as the hydrophobic solvent usable in surface treatment of the substrate particle. It is preferable that the colored particle for an EWD be obtained using the hydrophobic solvent, and then taken from the hydrophobic solvent, and dispersed in the hydrophobic solvent to obtain the ink for an EWD.

In order to further enhance the dispersibility of the colored particle for an EWD, the ink for an EWD may contain a surfactant. However, it is preferable that the content of the surfactant be smaller in order to further improve the driving response of EWD in the ink for an EWD. Therefore, it is preferable that the ink for an EWD do not contain a surfactant or if it contains a surfactant, the content of the surfactant in 100% by mass of the ink be 5% by mass or less.

Examples of the surfactant usable in the ink for an EWD may include a surfactant that is the same as the surfactant usable in polymerization of the polymerizable compound and a surfactant that is the same as the surfactant usable in surface treatment of the substrate particle.

The content of the colored particle for an EWD in 100% by mass of the ink is preferably 5% by mass or more, and more preferably 10% by mass or more, and preferably 50% by mass or less, and more preferably 30% by mass or less. When the content of the colored particle for an EWD is equal to or more than the lower limit or equal to or less than the upper limit, the hiding properties due to the colored particle are further enhanced, and the flowability of the colored particle in the ink is further enhanced. Therefore, the viewing quality of EWD is further enhanced.

The content of the hydrophobic solvent in 100% by mass of the ink is preferably 50% by mass or more, and more preferably 70% by mass or more, and preferably 95% by mass or less, and more preferably 90% by mass or less. When the content of the hydrophobic solvent is equal to or more than the lower limit or equal to or less than the upper limit, the hiding properties due to the colored particle are further enhanced, and the flowability of the colored particle in the ink is further enhanced. Therefore, the viewing quality of an EWD is further enhanced.

The ink for an EWD may contain an antioxidant, an ultraviolet radiation preventing agent, an organic dispersant, and a surfactant, if necessary.

(Electrowetting Display)

An EWD according to the present invention includes first and second opposed substrates, a first liquid that is disposed on a side of the first substrate between the first and second substrates, and an ink for an EWD (second liquid) that is disposed on a side of the second substrate between the first and second substrates. In the EWD according to the present invention, the ink for an EWD contains the colored particle for an EWD and the hydrophobic solvent.

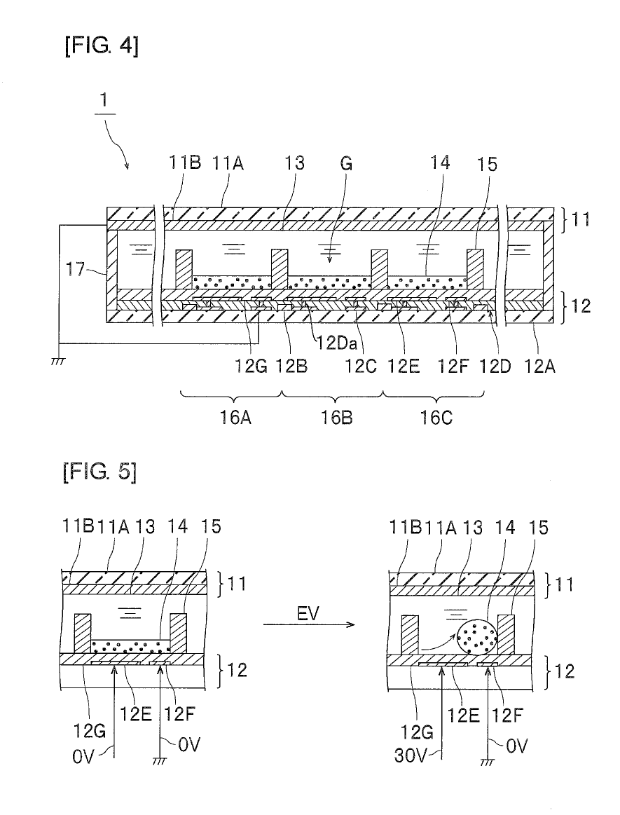

FIG. 4 is a cross-sectional view schematically illustrating an EWD using a colored particle for an EWD according to an embodiment of the present invention. FIG. 5 is a cross-sectional view schematically illustrating an action concept of the EWD. Note that structures not necessary to be described are shown as simplified in FIG. 5.

An EWD 1 shown in FIG. 4 has a first substrate 11 and a second substrate 12. The first substrate 11 and the second substrate 12 are disposed so as to be opposed through a first liquid 13. The first liquid 13 is disposed in a region (cell) comparted by a sealing material 17, which is provided along a circumference of the first substrate 11 and the second substrate 12.

The first liquid 13 is disposed on the side of the first substrate 11 between the first substrate 11 and the second substrate 12. An ink for an EWD 14 is disposed on the side of the second substrate 12 between the first substrate 11 and the second substrate 12.

The first liquid 13 is a hydrophilic liquid. The hydrophilicity of the first liquid 13 is higher than that of the ink for an EWD 14. The first liquid 13 is a high-surface energy liquid. The high-surface energy liquid is a liquid having relatively high surface energy as compared with the ink for an EWD 14. The hydrophobicity of the ink for an EWD 14 is higher than that of the first liquid 13. The ink for an EWD 14 is a low-surface energy liquid. The low-surface energy liquid is a liquid having relatively low surface energy as compared with the first liquid 13.

It is preferable that the SP values of the first liquid 13 and the hydrophilic liquid be each 14 or more. It is preferable that the SP value of the hydrophobic solvent in the ink for an EWD 14 be 9 or less.

The first substrate 11 has a substrate 11A and a common electrode 11B. The second substrate 12 has a substrate 12A, a TFT 12B, a wiring part 12C, a flat film 12D, a pixel electrode 12E, a common electrode 12F, and an insulator film 12G.

As the substrates 11A and 12A, a substrate that is usually used as a panel substrate of viewing material, such as glass, a resin molded body, and a film, is used.

It is preferable that the common electrode 11B be a transparent electrode. As a material for the common electrode 11B, for example, ITO (indium tin oxide) is used.

In the second substrate 12, a surface of the insulator film 12G constituting an inner surface on a cell side is subjected to water-repellency treatment, for example, by a known method such as application of a fluororesin and thermal treatment.

A pixel wall 15 is formed on the insulator film 12G. The pixel wall 15 is formed in a lattice shape, and comparts a plurality of the pixels G on the second substrate 12. One pixel G corresponds to one electrowetting (EW) element 16A, 16B, or 16C.

The pixel electrode 12E and the common electrode 12F are formed on the flat film 12D, and are connected with the TFT 12B and the wiring part 12C through a contact hole 12Da. A pair of the pixel electrode 12E and the common electrode 12F is disposed in each of the pixels G. The ink for an EWD 14 is stored in the region comparted by the pixel wall 15. The pixel wall 15 has a surface that is fitted to the first liquid 13.

As an electrode material for the pixel electrode 12E and the common electrode 12F, ITO, Al, or the like is used. When ITO is used as the electrode material, the EWD 1 is a transmission type display that is provided with a light source (not shown in the drawings) on a back surface side of the second substrate 12. When Al is used as an electrode material, the EWD 1 is a reflection type display in which light from outside is reflected on a surface of the electrode.

In such an EWD 1, when a predetermined voltage EV (e.g., 30 V) is applied to the pixel electrode 12E, as shown in FIG. 5, a capacitor in which the pixel electrode 12E and the first liquid 13 are used as electrodes and the insulator film 12G is used as a dielectric material is formed. By polarization of the insulator film 12G, a high-surface energy group of the first liquid 13 is attracted due to an electrostatic action. As a result, the ink for an EWD 14 on the pixel electrode 12E is pushed onto the common electrode 12F, and the shape of the ink changes.

By such application of a voltage, the ink for an EWD 14 in the pixel G can be selectively transferred onto the common electrode 12F.

The EWD shown in FIG. 4 is merely one example, and a structure of the EWD, or the like can be appropriately deformed.

Hereinafter, the present invention will be described specifically with reference to Examples and Comparative Examples. The present invention is not limited to the following Examples.

### Example 1

A 1,000-mL separable flask equipped with a four-necked separable cover, a stirrer blade, a three-way cock, a condenser, and a temperature probe was prepared. A solution containing 4 parts by mass of pyrrole (available from Wako Pure Chemical Industries, Ltd.), 400 parts by mass of toluene (available from Wako Pure Chemical Industries, Ltd.), 4 parts by mass of polystyrene-polyisoprene copolymer (organic dispersant as a surface-forming material, “Kuraprene LIR-310” available from KURARAY CO., LTD., weight average molecular weight: 32,000), 0.04 parts by mass of FeCl₃ (available from Wako Pure Chemical Industries, Ltd.), and 8 parts by mass of ethanol (available from Wako Pure Chemical Industries, Ltd.) was placed in this separable flask. 30 parts by mass of tert-butyl peroxypivalate (“Kayaester P-70” available from Kayaku Akzo Corporation) was finally added with stirring, resulting in polymerization at 25° C. for 12 hours in a nitrogen atmosphere. Then, centrifugation and cleaning were performed to obtain a polymer particle for an EWD (colored particle for an EWD, black particle, average particle diameter: 100 nm, spherical).

2 parts by mass of the obtained polymer particle for an EWD was added to 18 parts by mass of toluene as a hydrophobic solvent, and the mixture was stirred to obtain an ink for an EWD.

### Examples 2 to 4

A polymer particle for an EWD (colored particle for an EWD, black particle, average particle diameter: 150 nm, spherical) and an ink for an EWD were obtained in the same manner as in Example 1 except that the kind of organic dispersant as a surface-forming material was changed as shown in Table 1.

The weight average molecular weight of polyisoprene (“Kuraprene LIR-50” available from KURARAY CO., LTD.) used in Example 2 was 54,000. The weight average molecular weight of polydodecyl methacrylate (in-house synthesized product) used in Example 3 was 50,000. The weight average molecular weight of polyisoprene-poly(2-vinyl pyridine) copolymer (“P257-Ip2VP” available from Polymer Source Inc.) used in Example 4 was 12,500.

### Comparative Example 1

A polymer particle for an EWD and an ink for an EWD were obtained in the same manner as in Example 1 except that the kind of organic dispersant as a surface-forming material was changed as shown in Table 1.

The molecular weight of polymethyl methacrylate used in Comparative Example 1 was 15,000.

(Evaluation of Examples 1 to 4 and Comparative Example 1)

(1) Atom Configuration of Compound on Particle Surface

An atom structure on a surface of each of the resulting polymer particles for an EWD was determined by the following method.

[Elementary analysis of carbon atom, hydrogen atom, nitrogen atom, oxygen atom, and sulfur atom]

The polymer particle for an EWD was dried for 24 hours in a vacuum oven. Then, the quantity of each atom was determined with a Micro Corder JM10 manufactured by J-SCIENCE LAB CO., Ltd.

[Measurement of Specific Gravity]

The polymer particle for an EWD was dried for 24 hours in a vacuum oven. Then, the specific gravity was measured with a true specific gravity measurement device (“AccuPyc1330” manufactured by Shimadzu Corporation).

[Measurement of Particle Diameter]

The ink for an EWD was dropped onto a microgrid with a support film for STEM (ultra high resolution carbon support film, available from Okenshoji Co., Ltd.) with a micropipette and dried. The particle diameter of a core formed from a π-conjugated polymer and the particle diameter of the polymer particle for an EWD were measured utilizing a STME function with a scanning electron microscope S-4800 manufactured by Hitachi High-Technologies Corporation.

[Synthesis and Analysis of π-Conjugated Polymer for Reference]

Polymerization was performed by the same method as the method for producing a polymer particle for an EWD in Examples and Comparative Example except that an organic dispersant as a surface-forming material was not used, and a π-conjugated polymer was obtained. The elemental analysis, specific gravity measurement, and particle diameter measurement of the π-conjugated polymer were performed by the methods described above.

[Calculation of Atom Configuration of Compound on Particle Surface]

The content (X) of element X (atom X) of the compound on the surface of the polymer particle for an EWD is calculated by the following expression. In the following expression, Mₓ represents the content of element X in the polymer particle for an EWD, mₓ represents the content of element X in the π-conjugated polymer for reference, Gₓ represents the specific gravity of polymer particle for an EWD, gₓ represents the specific gravity of π-conjugated polymer for reference, Rₓ represents the particle diameter of the polymer particle for an EWD, and rₓ represents the particle diameter of the core formed from the π-conjugated polymer in the polymer particle for an EWD. X is carbon, hydrogen, oxygen, nitrogen, or sulfur.

$$Content ( X ) = \frac{4}{3} π \{ {( \frac{{R}_{x}}{2} )}^{3} \cdot {G}_{x} \cdot {M}_{x} - {( \frac{{r}_{x}}{2} )}^{3} \cdot {g}_{x} \cdot {m}_{x} \} \qquad [ Expression 1 ]$$

The mass ratio of the amount of carbon atom (content (C)) to the total of the amount of oxygen atom (content (O)), the amount of nitrogen atom (content (N)), and the amount of sulfur atom (content (S)) is calculated by the following expression.

Ratio=content (C)/(content (O)+content (N)+content (S))

The atom configuration of the compound on the particle surface was determined in accordance with the following criteria.

[Criteria of Atom Configuration of Compound on Particle Surface]

A: A particle surface is formed from a first compound containing only a carbon atom and a hydrogen atom as constituent atoms.

B: A particle surface is formed from a second compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more.

C: Both criteria A and B are not satisfied.

(2) Dispersibility 1

The ink for an EWD immediately after production was placed in a tubular container with an internal diameter of 1 cm until a height of 10 cm, and allowed to stand for 24 hours. The ink for an EWD after standing was observed, and dispersibility 1 was determined in accordance with the following criteria.

[Criteria of Dispersibility 1]

Good: A transparent supernatant is not produced.

Poor: A colored particle for an EWD (polymer particle for an EWD) was settled and a transparent supernatant was produced.

(3) Dispersibility 2

5 g of the ink for an EWD immediately after production and 5 g of water were placed in a 20-mL sample bottle, stirred, and allowed to stand. The ink for an EWD after standing was observed, and dispersibility 2 was determined in accordance with the following criteria.

[Criteria of Dispersibility 2]

Excellent: Even 72 hours after standing, a colored particle for an EWD (polymer particle for an EWD) does not aggregate in an interface between a hydrophobic solvent and water.

Good: Even 24 hours after standing, a colored particle for an EWD (polymer particle for an EWD) does not aggregate in an interface between a hydrophobic solvent and water, but 72 hours after standing, the polymer particle for an EWD aggregates in the interface between the hydrophobic solvent and water.

Poor: 24 hours after standing, a colored particle for an EWD (polymer particle for an EWD) aggregates in an interface between a hydrophobic solvent and water.

The results are shown in Table 1. The polymer particles for an EWD obtained in Examples 1 to 4 are a core-shell particle having a shell derived from an organic dispersant over the whole region of the particle surface. All the specific gravities of the polymer particles for an EWD obtained in Examples 1 to 4 are 2 or less. All the average aspect ratios of the polymer particles for an EWD obtained in Examples 1 to 4 are 1.5 or less.

TABLE 1
Polymer particle for EWD

| | | | Ex. 1 | Ex. 2 | Ex. 3 | Ex. 4 | Comp. Ex. 1 |
|---|---|---|---|---|---|---|---|
| Mixing | Polymerizable | Kind | Pyrrole | Pyrrole | Pyrrole | Pyrrole | Pyrrole |
| component | compound | Addition amount | 4 | 4 | 4 | 4 | 4 |
| | | (part by mass) | | | | | |
| | Oxidative | Kind 1 | Tert-butyl | Tert-butyl | Tert-butyl | Tert-butyl | Tert-butyl |
| | polymerization | | peroxypivalate | peroxypivalate | peroxypivalate | peroxypivalate | peroxypivalate |
| | initiator | Addition amount | 30 | 30 | 30 | 30 | 30 |
| | | (part by mass) | | | | | |
| | | of kind 1 | | | | | |
| | | Kind 2 | FeCl₃ + ethanol | FeCl₃ + ethanol | FeCl₃ + ethanol | FeCl₃ + ethanol | FeCl₃ + ethanol |
| | | Addition amount | 0.04 + 8 = 8.04 | 0.04 + 8 = 8.04 | 0.04 + 8 = 8.04 | 0.04 + 8 = 8.04 | 0.04 + 8 = 8.04 |
| | | (part by mass) | | | | | |
| | | of kind 2 | | | | | |
| | Solvent | Kind | Toluene | Toluene | Toluene | Toluene | Toluene |
| | | Addition amount | 400 | 400 | 400 | 400 | 400 |
| | | (part by mass) | | | | | |
| | Surface-forming | Kind | Polystyrene- | Polyisoprene | Polydodecyl | Polyisoprene- | Polymethyl |
| | material | | polyisoprene | | methacrylate | poly(2-vinyl | methacrylate |
| | (Organic | | copolymer | | | pyridine) | |
| | dispersant) | | | | | copolymer | |
| | | Addition amount | 4 | 4 | 4 | 4 | 4 |
| | | (part by mass) | | | | | |

| | | | | | | |
|---|---|---|---|---|---|---|
| Evaluation | Atom configuration of | A | A | B | A | C |
| | compound on particle surface | | | | | |
| | Dispersibility 1 | ∘ | ∘ | ∘ | ∘ | x |
| | Dispersibility 2 | ∘∘ | ∘∘ | ∘ | ∘∘ | x |

The first liquid (hydrophilic liquid, high surface energy liquid) and each ink for an EWD obtained in Examples 1 to 4 were disposed between the first and second substrates to produce an EWD shown in FIG. 4. The EWD using each ink for an EWD obtained in Examples 1 to 4 was confirmed to have sufficient hiding properties and to obtain a good viewing image during driving.

### Example 5

A carbon particle (“DENKA BLACK” available from DENKI KAGAKU KOGYO KABUSHIKI KAISHA, average particle diameter: 35 nm) was prepared.

5 parts by mass of carbon black was added to a solution of 5 parts by mass of polystyrene-polyisoprene copolymer (surface-forming material) in 200 parts by mass of toluene, and the mixture was treated with an ultrasonic homogenizer. During the treatment, 200 parts by mass of undecane was gradually added, and the mixture was further treated. After the treatment, toluene was removed under reduced pressure. After the ultrasonic treatment, the solution was allowed to stand for 1 day, a supernatant was collected, centrifuged, and cleaned with undecane. Thus, a surface portion (shell) derived from the surface-forming material was formed to obtain a carbon-modified particle for an EWD (average particle diameter: 210 nm).

2 parts by mass of the carbon-modified particle for an EWD was dispersed in 18 parts by mass of undecane to obtain an ink for an EWD.

The weight average molecular weight of polystyrene-polyisoprene copolymer (available from Zeon Corporation) used in Example 5 was 160,000.

### Examples 6 and 7

A carbon-modified particle for an EWD (colored particle for an EWD, black particle, average particle diameter: 150 nm) and an ink for an EWD were obtained in the same manner as in Example 5 except that the kind of surface-forming material was changed as shown in Table 2.

The weight average molecular weight of polydodecyl methacrylate (in-house synthesized product) used in Example 6 was 50,000. The weight average molecular weight of polyisoprene-poly(4-vinyl pyridine) copolymer (“P3060-Ip4VP” available from Polymer Source Inc.) used in Example 7 was 39,200.

### Comparative Example 2

The carbon particle prepared in Example 5 was used as a carbon particle for an EWD without modification as it was. 2 parts by mass of the carbon particle for an EWD was added to 18 parts by mass of undecane as a hydrophobic solvent, and the mixture was stirred to obtain an ink for an EWD.

### Comparative Example 3

A carbon-modified particle for an EWD and an ink for an EWD were obtained in the same manner as in Example 5 except that the kind of surface-forming material was changed as shown in Table 2.

The molecular weight of polymethyl methacrylate (available from Sigma-Aldrich) used in Comparative Example 3 was 15,000.

(Evaluation of Examples 5 to 7 and Comparative Examples 2 and 3)

(1) Atom Configuration of Compound on Particle Surface

An atom structure on a surface of each of the resulting carbon(-modified) particles for an EWD was determined by the following method.

[Elementary analysis of carbon atom, hydrogen atom, nitrogen atom, oxygen atom, and sulfur atom]

The resulting carbon-modified particle for an EWD was dried for 24 hours in a vacuum oven. Then, the quantity of each atom was determined with a Micro Corder JM10 manufactured by J-SCIENCE LAB CO., Ltd.

The mass ratio of the amount of carbon atom (content (C)) to the total of the amount of oxygen atom (content (O)), the amount of nitrogen atom (content (N)), and the amount of sulfur atom (content (S)) is calculated by the following expression.

Ratio=content (C)/(content (O)+content (N)+content (S))

The atom configuration of the compound on the particle surface was determined in accordance with the following criteria.

[Criteria of Atom Configuration of Compound on Particle Surface]

A: A particle surface is formed from a first compound containing only a carbon atom and a hydrogen atom as constituent atoms.

B: A particle surface is formed from a second compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more.

C: Both criteria A and B are not satisfied.

(2) Dispersibility 1

Dispersibility 1 was evaluated in the same manner as in Examples 1 to 4 and Comparative Example 1.

(3) Dispersibility 2

Dispersibility 2 was evaluated in the same manner as in Examples 1 to 4 and Comparative Example 1.

The results are shown in Table 2. The carbon-modified particles for an EWD obtained in Examples 5 to 7 are a core-shell particle having a shell derived from an organic dispersant over the whole region of the particle surface. All the specific gravities of the carbon-modified particles for an EWD obtained in Examples 5 to 7 are 2 or less. All the average aspect ratios of the carbon-modified particles for an EWD obtained in Examples 5 to 7 are 1.5 or less. In Table 2, “-” represents that evaluation is not performed.

TABLE 2
Carbon-modified particle for an EWD

| | | Ex. 5 | Ex. 6 | Ex. 7 | Comp. Ex. 2 | Comp. Ex. 3 |
|---|---|---|---|---|---|---|
| Kind of surface-forming material | | Polystyrene- | Polydodecyl | Polyisoprene- | — | Polymethyl |
| | | polyisoprene | methacrylate | poly(4-vinyl | | methacrylate |
| | | copolymer | | pyridine) | | |
| | | | | copolymer | | |
| Evaluation | Atom configuration | A | B | A | — | C |
| | of compound on | | | | | |
| | particle surface | | | | | |
| | Dispersibility 1 | ∘ | ∘ | ∘ | x | x |
| | Dispersibility 2 | ∘∘ | ∘ | ∘∘ | x | x |

Since the carbon-modified particles in Examples 5 to 7 have a surface portion that is formed from a specific resin on a surface of the carbon particle, the conductivity is lower as compared with a carbon particle alone.

The first liquid (hydrophilic liquid, high surface energy liquid) and each ink for an EWD obtained in Examples 5 to 7 and Comparative Example 2 were disposed between the first and second substrates to produce an EWD shown in FIG. 4. The EWD using each ink for an EWD obtained in Examples 5 to 7 was confirmed to have sufficient hiding properties and to obtain a good viewing image during driving. In contrast, since in the ink for an EWD obtained in Comparative Example 2, the conductivity of the carbon particle was high, a good viewing image during driving was not obtained.

Since the carbon-modified particles in Examples 5 to 7 each have a surface portion that is formed from a specific resin on a surface of the carbon particle, the dispersibility in the hydrophobic solvent is higher as compared with a carbon particle alone. In contrast, since in Comparative Examples 2 and 3, a surface portion is not formed from the specific resin, the dispersibility in the hydrophobic solvent is low. Therefore, a good viewing image during driving of the EWD was not obtained.

### Example 8

A 1,000-mL separable flask equipped with a four-necked separable cover, a stirrer blade, a three-way cock, a condenser, and a temperature probe was prepared. 4 parts by mass of pyrrole (available from Wako Pure Chemical Industries, Ltd.), 5 parts by mass of polyvinylpyrrolidone (“K30” available from Wako Pure Chemical Industries, Ltd.) as a dispersion stabilizer, and 400 parts by mass of distilled water were placed in the separable flask, and stirred at room temperature, to obtain a mixed solution.

Subsequently, a solution of 7.0 parts by mass of ammonium persulfate (available from Wako Pure Chemical Industries, Ltd.) as a polymerization initiator in 100 parts by mass of distilled water was added dropwise to the mixed solution. After completion of dropwise addition, the mixed solution was stirred for 8 hours, resulting in polymerization, to obtain a dispersion solution.

The resulting dispersion solution was subjected to centrifugation and ultrasonic dispersion with distilled water one time, and centrifugation and ultrasonic dispersion with ethanol one time. An unreacted monomer and the initiator were removed. The dispersion solution was cleaned to obtain a dispersion solution of a polypyrrole particle in ethanol. The concentration of the polypyrrole particle was adjusted to 2% by mass to obtain an ethanol dispersion solution.

Subsequently, a solution of 4 parts by mass of polystyrene-polyisoprene copolymer as a surface-forming material in 200 parts by mass of toluene was added to 200 g of the ethanol dispersion solution containing 2% by mass of the polypyrrole particle with stirring, and 100 parts by mass of undecane was further added. Then, ethanol and toluene were removed under reduced pressure. The solution was centrifuged, and cleaned with undecane to form a surface portion (shell) derived from the surface-forming material on a surface of the polypyrrole particle. Thus, a polymer particle for an EWD (colored particle for an EWD, black particle, average particle, diameter: 100 nm, spherical) was obtained.

2 parts by mass of the polymer particle for an EWD was added to 18 parts by mass of undecane as a hydrophobic solvent, and dispersed to obtain an ink for an EWD.

### Example 9

A surface portion (shell) derived from the surface-forming material was formed on a surface of a PEDOT particle in the same manner as in Example 8 except that 5 parts by mass of 3,4-ethylenedioxythiophene (EDOT) (available from Tokyo Chemical Industry Co., Ltd.) was used as the polymerizable compound and the use amount of the polymerization initiator was changed to 13.5 parts by mass. Thus, a polymer particle for an EWD (colored particle for an EWD, black particle, average particle diameter: 60 nm, spherical) was obtained.

2 parts by mass of the polymer particle for an EWD was added to 18 parts by mass of undecane as a hydrophobic solvent, and dispersed to obtain an ink for an EWD.

### Example 10

A 1,000-mL separable flask equipped with a four-necked separable cover, a stirrer blade, a three-way cock, a condenser, and a temperature probe was prepared. 50 parts by mass of styrene (available from Wako Pure Chemical Industries, Ltd.), 5 parts by mass of divinyl benzene (available from Tokyo Chemical Industry Co., Ltd.), 0.3 parts by mass of sodium p-styrenesulfonate (available from Wako Pure Chemical Industries, Ltd.), 0.2 parts by mass of potassium persulfate (available from Wako Pure Chemical Industries, Ltd.), and 500 parts by mass of distilled water were placed in the separable flask, and subjected to polymerization at 70° C. for 12 hours in a nitrogen atmosphere, to obtain an aqueous dispersion solution of organic particle. The resulting aqueous dispersion solution of organic particle was subjected to centrifugation and ultrasonic dispersion with distilled water two times. An unreacted monomer and the initiator were removed. The dispersion solution was cleaned to obtain a dispersion solution of polystyrene particle.

Subsequently, 100 parts by mass of the dispersion solution containing 1% by weight of the polystyrene particle, 4 parts by mass of pyrrole (available from Wako Pure Chemical Industries, Ltd.), 5 parts by mass of polyvinylpyrrolidone (“K30” available from Wako Pure Chemical Industries, Ltd.) as a dispersion stabilizer, and 300 parts by mass of distilled water were placed in a 1,000-mL separable flask equipped with a four-necked separable cover, a stirrer blade, a three-way cock, a condenser, and a temperature probe, and stirred at room temperature, to obtain a mixed solution.

A solution of 7.0 parts by mass of ammonium persulfate (available from Wako Pure Chemical Industries, Ltd.) as a polymerization initiator in 100 parts by mass of distilled water was added dropwise to the mixed solution. After completion of dropwise addition, the mixed solution was stirred for 8 hours, resulting in polymerization.

After the polymerization, the same operation as in Example 8 was performed to form a surface portion (shell) derived from the surface-forming material on a surface of a polymer substrate particle in which an organic polystyrene particle is coated with polypyrrole. Thus, a polymer particle for an EWD (colored particle for an EWD, black particle, average particle diameter: 250 nm, spherical) was obtained.

2 parts by mass of the polymer particle for an EWD was added to 18 parts by mass of undecane as a hydrophobic solvent, and dispersed to obtain an ink for an EWD.

### Example 11

A polymer particle for an EWD (colored particle for an EWD, black particle, average particle diameter: 240 nm) and an ink for an EWD were obtained in the same manner as in Example 10 except that 4 parts by mass of thiophene (available from Tokyo Chemical Industry Co., Ltd.) was used as the polymerizable compound and the kind of surface-forming material was changed as shown in Table 3.

The weight average molecular weight of polyisoprene-poly(2-vinyl pyridine) copolymer (“P257-Ip2VP” available from Polymer Source Inc.) used in Example 11 was 12,500.

### Comparative Example 4

A polymer particle for an EWD and an ink for an EWD were obtained in the same manner as in Example 8 except that the kind of organic dispersant as a surface-forming material was changed as shown in Table 3.

(Evaluation of Examples 8 to 11 and Comparative Example 4)

(1) Atom Configuration of Compound on Particle Surface

An atom structure on a surface of each of the obtained polymer particles for an EWD was determined in the same manner as in Examples 1 to 4 and Comparative Example 1.

(2) Dispersibility 1

Dispersibility 1 was evaluated in the same manner as in Examples 1 to 4 and Comparative Example 1.

(3) Dispersibility 2

Dispersibility 2 was evaluated in the same manner as in Examples 1 to 4 and Comparative Example 1.

The results are shown in Table 3. The polymer particles for an EWD obtained in Examples 8 to 11 are a core-shell particle having a shell derived from an organic dispersant over the whole region of the particle surface. All the specific gravities of the polymer particles for an EWD obtained in Examples 8 to 11 are 2 or less. All the average aspect ratios of the polymer particles for an EWD obtained in Examples 8 to 11 are 1.5 or less.

TABLE 3
Polymer particle for EWD

| | | | Ex. 8 | Ex. 9 | Ex. 10 | Ex. 11 | Comp. Ex. 4 |
|---|---|---|---|---|---|---|---|
| Mixing | Polymerizable | Kind | Pyrrole | EDOT | Pyrrole | Thiophene | Pyrrole |
| component | compound | Addition amount | 4 | 5 | 4 | 4 | 4 |
| | | (part by mass) | | | | | |
| | Oxidative | Kind 1 | Ammonium | Ammonium | Ammonium | Ammonium | Ammonium |
| | polymerization | | persulfate | persulfate | persulfate | persulfate | persulfate |
| | initiator | Addition amount | 7 | 13.5 | 7 | 7 | 7 |
| | | (part by mass) | | | | | |
| | | of kind 1 | | | | | |
| | | Kind 2 | — | — | — | — | — |
| | | Addition amount | — | — | — | — | — |
| | | (part by mass) | | | | | |
| | | of kind 2 | | | | | |
| | Solvent | Kind | Water | Water | Water | Water | Water |
| | | Addition amount | 500 | 500 | 500 | 500 | 500 |
| | | (part by mass) | | | | | |
| | Surface-forming | Kind | Polystyrene- | Polystyrene- | Polystyrene- | Polyisoprene- | Polymethyl |
| | material | | polyisoprene | polyisoprene | polyisoprene | poly(2-vinyl | methacrylate |
| | (Organic dispersant) | | copolymer | copolymer | copolymer | pyridine) | |
| | | | | | | copolymer | |
| | | Addition amount | 4 | 4 | 4 | 4 | 4 |
| | | (part by mass) | | | | | |

| | | | | | | |
|---|---|---|---|---|---|---|
| | Other component | — | — | Polystyrene | Polystyrene | — |
| | | | | particle | particle | |
| Evaluation | Atom configuration of compound | A | A | A | A | C |
| | on particle surface | | | | | |
| | Dispersibility 1 | ∘ | ∘ | ∘ | ∘ | x |
| | Dispersibility 2 | ∘∘ | ∘∘ | ∘∘ | ∘∘ | x |

The first liquid (hydrophilic liquid, high surface energy liquid) and each ink for an EWD obtained in Examples 8 to 11 were disposed between the first and second substrates to produce the EWD shown in FIG. 4. The EWD using each ink for an EWD obtained in Examples 8 to 11 was confirmed to have sufficient hiding properties and to obtain a good viewing image during driving.

### Example 12

Dye-containing core particle 1 (dye-containing particle material):

50 parts by mass of Solvent Black 3 (available from ARIMOTO CHEMICAL CO., LTD.) was uniformly dissolved in 45 parts by mass of butyl methacrylate (available from KYOEISHA CHEMICAL CO., LTD.), 5 parts by mass of ethylene glycol dimethacrylate (available from MITSUBISHI RAYON CO., LTD.), and 10 parts by mass of ethanol to obtain a dissolved solution. The dissolved solution was added to 1,000 parts by mass of ion-exchange water containing 1% by mass of sodium dodecyl benzenesulfonate (available from Wako Pure Chemical Industries, Ltd.), stirred, and emulsified with an ultrasonic homogenizer UH-600 (manufactured by SMT), and the emulsified solution was placed in a 2,000-mL separable flask.

The separable flask was set in a four-necked separable cover equipped with a condenser, a three-way cock, and a stirrer blade, and purged with nitrogen with stirring for 3 hours. The temperature was then increased to 75° C.

After the temperature was increased, 50 parts by mass of ion-exchange water in which 1.2 parts by mass of potassium persulfate (available from Wako Pure Chemical Industries, Ltd.) was dissolved was placed in the separable flask, to initiate polymerization. After polymerization at 75° C. for 12 hours, the separable flask was cooled to room temperature to stop the polymerization. By this operation, a dye-containing core particle 1 was obtained. The average particle diameter of the dye-containing core particle 1 was 60 nm.

Dye-Containing Particle for EWD 1 and Ink for EWD 1:

The dye-containing core particle 1 was centrifuged, a supernatant was removed, and ethanol was added. The particle 1 was dispersed by ultrasonic irradiation. This operation was repeated two times, to obtain an ethanol dispersion solution of the dye-containing core particle 1 having a solid content of 2% by mass. 50 parts by mass of toluene containing 1 part by mass of styrene-isoprene block polymer (available from KURARAY CO., LTD.) was added to 50 parts by mass of the ethanol dispersion solution of the dye-containing core particle 1, and the mixture was uniformly stirred. Further, 100 parts by mass of undecane was added, and ethanol and toluene were then distilled off by evaporation. After that, centrifugation and dispersion with undecane were repeated two times, the solid content concentration was adjusted to a predetermined concentration to obtain a dye-containing particle for an EWD 1 having a surface portion (surface layer) that was formed from a styrene-isoprene block polymer and an ink for an EWD 1 (solid content: 10% by mass) in which the dye-containing particle for EWD 1 was dispersed in undecane. The average particle diameter of the dye-containing particle for an EWD 1 was 65 nm.

### Example 13

### Dye-Containing Core Particle 2

10 parts by mass of Solvent Black 3 (available from ARIMOTO CHEMICAL CO., LTD.) as a dye was dissolved in 300 parts by mass of ethanol. To the dissolved solution of the dye, 100 parts by mass of aqueous dispersion solution (solid content: 10% by mass) (available from SEKISUI MEDICAL CO., LTD.) of polystyrene particle (average particle diameter: 120 nm) obtained by soap-free emulsion polymerization was added and the mixture was uniformly dispersed. 600 parts by mass of ion-exchange water was added dropwise over 6 hours. By this operation, a dye-containing core particle 2 was obtained. The average particle diameter of the dye-containing core particle 2 was 150 nm.

Dye-Containing Particle for EWD 2 and Ink for EWD 2:

The dye-containing core particle 2 was subjected to the same operation as in Example 12 to obtain a dye-containing particle for EWD 2 and an ink for EWD 2. The average particle diameter of the dye-containing particle for an EWD 2 was 155 nm.

### Example 14

The dye-containing particle for EWD 3 and an ink for EWD 3 were obtained by the same operation as in Example 12 except that a styrene-isoprene block polymer was changed to polydodecyl methacrylate. The average particle diameter of the dye-containing particle for an EWD 3 was 65 nm.

### Example 15

An ink for an EWD 4 was obtained in the same manner as in Example 12 except that centrifugation and re-dispersion with toluene were performed again after the dye-containing particle for an EWD 1 that was dispersed in undecane was obtained, and toluene was used as a dispersion medium in Example 12.

### Example 16

An ink for an EWD 5 was obtained by the same operation as in Example 13 except that a styrene-isoprene block polymer was changed to a polyisoprene-poly(4-vinyl pyridine) copolymer. The weight average molecular weight of polyisoprene-poly(4-vinyl pyridine) copolymer (“P3060-Ip4VP” available from Polymer Source Inc.) used in Example 11 was 39,200.

### Comparative Example 5

The dye-containing core particle 1 (dye-containing particle material) obtained in Example 12 was used as the dye-containing particle for an EWD. 2 parts by mass of the dye-containing particle for an EWD was added to 18 parts by mass of undecane as a hydrophobic solvent, and the mixture was stirred to obtain an ink for an EWD 6.

### Comparative Example 6

Solvent Black 3 (available from ARIMOTO CHEMICAL CO., LTD.) used as a dye in Example 12 was used as a dye for an EWD. 2 parts by mass of the dye for an EWD was added to 18 parts by mass of undecane as a hydrophobic solvent, and the mixture was stirred to obtain an ink for an EWD 7.

### Evaluation of Examples 12 to 16 and Comparative Examples 5 and 6

### (1) Atom Configuration of Compound on Particle Surface

An atom structure on a surface of the dye-containing particle for an EWD and the dye particle for an EWD was determined by the following method.

[Elementary analysis of carbon atom, hydrogen atom, nitrogen atom, oxygen atom, and sulfur atom]

The resulting dye-containing particle for an EWD was dried for 24 hours in a vacuum oven. Then, the quantity of each atom was determined with a Micro Corder JM10 manufactured by J-SCIENCE LAB CO., Ltd.

[Measurement of Specific Gravity]

The resulting dye-containing particle for an EWD and the dye particle for an EWD were dried for 24 hours in a vacuum oven. Then, the specific gravity was measured with a true specific gravity measurement device (“AccuPyc1330” manufactured by Shimadzu Corporation).

[Measurement of Particle Diameter]

The ink for an EWD was dropped onto a microgrid with a support film for STEM (ultra high resolution carbon support film, available from Okenshoji Co., Ltd.) with a micropipette and dried. The particle diameter of a core formed from a dye-containing particle and the particle diameter of the resultant dye-containing particle for an EWD were measured utilizing a STME function with a scanning electron microscope S-4800 manufactured by Hitachi High-Technologies Corporation.

[Synthesis and Analysis of Dye-Containing Particle for Reference]

Polymerization was performed by the same method as the method for producing a dye-containing particle for an EWD in Examples and Comparative Examples except that a surface-forming material was not used, and a dye-containing particle was obtained. The elemental analysis, specific gravity measurement, and particle diameter measurement of the dye-containing particle were performed by the methods described above.

[Calculation of Atom Configuration of Compound on Particle Surface]

The content (X) of element X (atom X) of the compound on the surface of the dye-containing particle for an EWD is calculated by the following expression. In the following expression, Mₓ represents the content of element X in the dye-containing particle for an EWD, mₓ represents the content of element X in the dye-containing particle for reference, Gₓ represents the specific gravity of dye-containing particle for an EWD, gₓ represents the specific gravity of the dye-containing particle for reference, Rₓ represents the particle diameter of the dye-containing particle for an EWD, and rₓ represents the particle diameter of the core formed from the dye-containing particle in the dye-containing particle for an EWD. X is carbon, hydrogen, oxygen, nitrogen, or sulfur.

$$Content ( X ) = \frac{4}{3} π \{ {( \frac{{R}_{x}}{2} )}^{3} \cdot {G}_{x} \cdot {M}_{x} - {( \frac{{r}_{x}}{2} )}^{3} \cdot {g}_{x} \cdot {m}_{x} \} \qquad [ Expression 2 ]$$

The mass ratio of the amount of carbon atom (content (C)) to the total of the amount of oxygen atom (content (O)), the amount of nitrogen atom (content (N)), and the amount of sulfur atom (content (S)) is calculated by the following expression.

Ratio=content (C)/(content (O)+content (N)+content (S))

The atom configuration of the compound on the particle surface was determined in accordance with the same criteria as in Examples 1 to 4 and Comparative Example 1.

### (2) Weather Resistance

The solid content of the ink for an EWD immediately after production was adjusted to 0.01% by mass, and 20 mL of the ink was placed in a 50-mL glass container. The ink for an EWD in the container was exposed to artificial sunlight at 250 W/m² for 7 days with a weather resistance tester (SOLARBOX manufactured by CO.FO.ME.GRA.).

The absorbance of the ink for an EWD before and after the exposure was measured with an ultraviolet-visible spectrophotometer (UVmini-1240 manufactured by Shimadzu Corporation). A change in the average of the absorbance before and after exposure to artificial sunlight was calculated and the light fastness was determined in accordance with the following criteria.

[Criteria of Weather Resistance]

Good: The average of absorbance after exposure holds 95% or more of that before exposure, and the light fastness is excellent.

Poor: The average of absorbance after exposure is lower than 95% of that before exposure, and the light fastness is deteriorated.

(3) Dispersibility 1

Dispersibility 1 was evaluated in the same manner as in Examples 1 to 4 and Comparative Example 1.

(4) Dispersibility 2

Dispersibility 2 was evaluated in the same manner as in Examples 1 to 4 and Comparative Example 1.

(5) Resistance to Dye Elution

The ink for an EWD immediately after production was allowed to stand at room temperature for 24 hours. Then, the ink was centrifuged, and a supernatant liquid was collected. The presence or absence of colorization of the supernatant liquid was confirmed, and the resistance to dye elution was determined in the accordance with the following criteria.

[Criteria of Resistance to Dye Elution]

Good: A dye is not eluted and a hydrophobic solvent is not colorized.

Poor: A dye is eluted and a hydrophobic solvent is colorized.

The results are shown in Table 4. The dye-containing particles for an EWD obtained in Examples 12 to 16 are a core-shell particle having a shell derived from a surface-forming material over the whole region of the particle surface. All the specific gravities of the dye-containing particles for an EWD obtained in Examples 12 to 16 are 2 or less. All the average aspect ratios of the dye-containing particles for an EWD obtained in Examples 12 to 16 are 1.5 or less. In Table 4, “-” represents that evaluation is not performed.

TABLE 4

| | | Ex. 12 | Ex. 13 | Ex. 14 | Ex. 15 | Ex. 16 | Comp. Ex. 5 | Comp. Ex. 6 |
|---|---|---|---|---|---|---|---|---|
| Kind of material for substrate | | Poly(butyl | Polystyrene | Poly(butyl | Poly(butyl | Polystyrene | Poly(butyl | — |
| particle | | methacrylate) | | methacrylate) | methacrylate) | | methacrylate) | |
| Kind of surface-forming material | | Styrene- | Styrene- | Polydodecyl | Styrene- | Polyisoprene- | — | — |
| | | isoprene | isoprene | methacrylate | isoprene | poly(4-vinyl | | |
| | | block polymer | block polymer | | block polymer | pyridine) | | |
| | | | | | | copolymer | | |
| Kind of solvent in ink | | Undecane | Undecane | Undecane | Toluene | Undecane | Undecane | Undecane |
| Evaluation | Atom configuration | A | A | B | A | A | C | — |
| | of compound on | | | | | | | |
| | particle surface | | | | | | | |
| | Weather | ∘ | ∘ | ∘ | ∘ | ∘ | x | x |
| | resistance | | | | | | | |
| | Dispersibility 1 | ∘ | ∘ | ∘ | ∘ | ∘ | x | — |
| | Dispersibility 2 | ∘∘ | ∘∘ | ∘ | ∘∘ | ∘∘ | x | — |
| | Resistance to | ∘ | ∘ | ∘ | ∘ | ∘ | x | — |
| | dye elution | | | | | | | |

The first liquid (hydrophilic liquid, high surface energy liquid) and each ink for an EWD obtained in Examples 12 to 16 and Comparative Examples 5 and 6 were disposed between the first and second substrates to produce the EWD shown in FIG. 4. The EWD using each ink for an EWD obtained in Examples 12 to 16 was confirmed to have sufficient hiding properties and to obtain a good viewing image during driving. In contrast, since in the EWD obtained in Comparative Examples 5 and 6, the dispersibility of the particle was not sufficient, a good viewing image during driving was not obtained. The EWDs in Examples 12 to 16 and Comparative Examples 5 and 6 were built outside, and allowed to stand for 30 days. Even after standing for 30 days, the EWDs in Examples 12 to 16 were confirmed to obtain a good viewing image. In contrast, the EWDs obtained in Comparative Examples 5 and 6 were confirmed to have low weather resistance and decreased contrast.

### EXPLANATION OF SYMBOLS

1 . . . Electrowetting display (EWD)
11 . . . First substrate
12 . . . Second substrate
13 . . . First liquid
14 . . . Ink for electrowetting display (EWD)
15 . . . Pixel wall
16A, 16B, 160 . . . Electrowetting (EW) element
17 . . . Sealing material
21 . . . Polymer particle for electrowetting display (EWD)
22 . . . Polymer substrate particle
23 . . . Surface portion
31 . . . Carbon-modified particle for electrowetting display (EWD)
32 . . . Carbon particle
33 . . . Surface portion
41 . . . Dye-containing particle for electrowetting display (EWD)
42 . . . Dye-containing particle
43 . . . Surface portion

1. A colored particle for an electrowetting display having
a surface that is formed from a compound containing only a carbon atom and a hydrogen atom as constituent atoms; or
a surface that is formed from a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more.

2. The colored particle for an electrowetting display according to claim 1, wherein a surface-forming material to form the particle surface is a polymer of a polymerization component containing at least one selected from the group consisting of styrene, isoprene, isobutylene, 1-butene, 1-pentene, 1-hexene, 1-octene, and butadiene or a hydrogenated product of the polymer; or a polymer of alkyl (meth)acrylate having an alkyl group having 12 to 18 carbon atoms.

3. The colored particle for an electrowetting display according to claim 2, wherein the surface-forming material to form the particle surface is a polymer of a polymerization component containing at least one selected from the group consisting of styrene, isoprene, isobutylene, 1-butene, 1-pentene, 1-hexene, 1-octene, and butadiene or a hydrogenated product of the polymer.

4. The colored particle for an electrowetting display according to claim 1, comprising a polymer obtained by polymerization of a polymerizable compound that forms a n-conjugated polymer by polymerization, comprising a carbon particle, or comprising a dye.

5. The colored particle for an electrowetting display according to claim 4, comprising a polymer obtained by polymerization of a polymerizable compound that forms a π-conjugated polymer by polymerization or comprising a carbon particle.

6. The colored particle for an electrowetting display according to claim 5, which is obtained by polymerization of a polymerizable compound that forms a π-conjugated polymer by polymerization.

7. The colored particle for an electrowetting display according to claim 5, comprising a carbon particle.

8. The colored particle for an electrowetting display according to claim 7, comprising the carbon particle, and a surface portion that is disposed on a surface of the carbon particle and constitutes a particle surface.

9. A method for producing the colored particle for an electrowetting display according to claim 1, comprising:
a step of polymerizing a polymerizable compound that forms π-conjugated polymer by polymerization to obtain the colored particle for an electrowetting display of which the surface is formed from a compound containing only a carbon atom and a hydrogen atom as constituent atoms or the surface is formed from a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more,
a step of surface-treating a carbon particle to dispose a surface portion that constitutes a surface of the particle on a surface of the carbon particle, obtaining the colored particle for an electrowetting display of which the surface is formed from a compound containing only a carbon atom and a hydrogen atom as constituent atoms or the surface is formed from a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more; or
a step of surface-treating a dye-containing particle material that contains a substrate particle and a dye within the substrate particle to obtain the colored particle for an electrowetting display of which the surface is formed from a compound containing only a carbon atom and a hydrogen atom as constituent atoms or the surface is formed from a compound in which the total amount of a carbon atom, a hydrogen atom, an oxygen atom, a nitrogen atom, and a sulfur atom is 95% by mass or more relative to 100% by mass of total of constituent atoms, and the mass ratio of the amount of the carbon atom to the total amount of the oxygen atom, the nitrogen atom, and the sulfur atom is 5 or more.

10. An ink for an electrowetting display, comprising the colored particle for an electrowetting display according to claim 1 and a hydrophobic solvent.

11. An electrowetting display comprising
first and second opposed substrates,
a first liquid that is disposed on a side of the first substrate between the first and second substrates, and
an ink for an electrowetting display that is disposed on a side of the second substrate between the first and second substrates,
wherein the ink for an electrowetting display contains the colored particle for an electrowetting display according to claim 1 and a hydrophobic solvent.
